(19) United States
(12) Patent Application Publication
(10) Pub. No.: US 2026/0219421 A1
(43) Pub. Date: Jul. 30, 2026

(54) INFORMATION MANAGEMENT APPARATUS AND WEATHER MANAGEMENT APPARATUS

(71) Applicants: KABUSHIKI KAISHA TOSHIBA, Minato-ku, Tokyo (JP); TOSHIBA DIGITAL SOLUTIONS CORPORATION, Kawasaki-shi, Kanagawa (JP)

(72) Inventors: Masakazu WADA, Yokohama Kanagawa (JP); Takahisa WADA, Yokohama Kanagawa (JP)

(73) Assignees: KABUSHIKI KAISHA TOSHIBA, Minato-ku, Tokyo (JP); TOSHIBA DIGITAL SOLUTIONS CORPORATION, Kawasaki-shi, Kanagawa (JP)

(21) Appl. No.: 19/147,023

(22) PCT Filed: May 17, 2023
(86) PCT No.: PCT/JP2023/018373

§ 371 Date: Jul. 10, 2025

(30) Foreign Application Priority Data
Jan. 13, 2023 (JP) 2023-003540
Mar. 16, 2023 (JP) 2023-041975

(51) Int. Cl. G01W 1/10; G01W 1/18

(52) U.S. Cl. CPC G01W 1/10; G01W 1/18

(57) ABSTRACT

[PROBLEM] To provide an information management apparatus capable of matching observation results based on observation data acquired by a weather radar against an actual weather phenomenon and providing a true value (Ground Truth label) of the weather phenomenon corresponding to the observation data from the weather radar.

[SOLVING MEANS] An information management apparatus according to embodiments includes an information collection section configured to acquire weather-related posted information from multiple posted information posted to a Web server configured to receive posted information from poster terminals, an extraction section configured to extract the weather-related posted information that matches an observation area and an observation time of observation data observed by a weather radar, and a data management section configured to output a weather phenomenon found in the extracted the weather-related posted information as a weather phenomenon corresponding to the observation data.

### TECHNICAL FIELD

Embodiments of the present invention relate to a technique for matching observation results based on observation data acquired by a weather radar against an actual weather phenomenon and providing the true value (Ground Truth label) of the weather phenomenon corresponding to the observation data from the weather radar.

### BACKGROUND ART

Weather radars emit electromagnetic waves (microwaves) to observe rain and/or snow present within a predetermined range. The weather radars can measure the distance to the rain and/or snow from the time for the emitted electromagnetic waves to return and can observe the intensity of the rain and/or snow based on the intensity of the returned electromagnetic waves.

Dual polarization weather Doppler radars have recently been introduced and use horizontally vibrating electromagnetic waves (horizontally polarized waves) and vertically vibrating electromagnetic waves (vertically polarized waves) to allow determination of the category of precipitation particles within clouds and more accurate estimation of the intensity of precipitation.

### PRIOR ART DOCUMENTS

### Non-Patent Documents

[Non-Patent Document 1] Park, H. -S and A. V. Ryzhkov, D. S. Zrnic and K. -E Kim 2009: The Hydrometeor Classification Algorithm for the Polarimetric WSR-88D: Description and Application to and MCS. Wea. Forecasting., 24, 730-748
[Non-Patent Document 2] Hideaki Kagesawa (and five others), “A proposal and study of method for sensing by twitter” (Jul. 2, 2014,

URL:https://ipsj.ixsp.nii.ac.jp/ej/?action=pages_view_main&active_{—}
action=repository_view_main_item_detail&item_id=104972&item_no=1&p
age_id=13&block_id=8

### DISCLOSURE OF THE INVENTION

### Problems to be Solved by the Invention

It is an object of the present invention to provide an information management apparatus capable of matching observation results based on observation data acquired by a weather radar against an actual weather phenomenon and providing the true value (Ground Truth label) of the weather phenomenon corresponding to the observation data from the weather radar.

### Means for Solving the Problems

An information management apparatus according to an embodiment of the present invention includes an information collection section configured to acquire weather-related posted information from multiple posted information posted to a Web server configured to receive posted information from poster terminals, an extraction section configured to extract the weather-related posted information that matches an observation area and an observation time of observation data observed by a weather radar, and a data management section configured to output a weather phenomenon found in the extracted the weather-related posted information as a weather phenomenon corresponding to the observation data.

### BRIEF DESCRIPTION OF THE DRAWINGS

FIG. 1 A diagram showing functional blocks of an information management apparatus according to Embodiment 1 and the configuration of a network including the information management apparatus.

FIG. 2 A diagram for explaining processing of creating true-value information linked to a weather phenomenon found in posted information that corresponds to observation data according to Embodiment 1.

FIG. 3 A diagram for explaining processing of extracting weather-related posted information from posted information using various types of evaluation information according to Embodiment 1

FIG. 4 A diagram showing a flow of processing performed by the information management apparatus according to Embodiment 1.

FIG. 5 A diagram showing functional blocks of a weather management apparatus according to Embodiment 2 and the configuration of a network including the weather management apparatus.

FIG. 6 A diagram for explaining processing of changing a criterion according to Embodiment 1.

FIG. 7 A diagram showing a flow of processing performed by the weather management apparatus according to Embodiment 2.

FIG. 8 A diagram showing functional blocks of an information management apparatus according to Embodiment 3 and the configuration of a network including the information management apparatus.

FIG. 9 A diagram for explaining a first function of classifying weather-related posted information according to an insurance payment history and a second function of classifying weather-related posted information using a classification model according to Embodiment 3.

FIG. 10 A diagram showing a flow of processing of the first function performed by a classification control section according to Embodiment 3.

FIG. 11 A diagram showing a flow of processing performed by an information management apparatus according to Embodiment 3.

FIG. 12 A diagram showing a flow of processing performed by a weather management apparatus cooperating with the information management apparatus according to Embodiment 3.

FIG. 13 A diagram showing functional blocks of a weather management apparatus according to Embodiment 4 and the configuration of a network including the weather management apparatus.

FIG. 14 A diagram showing a flow of processing performed by the weather management apparatus according to Embodiment 4.

FIG. 15 A diagram showing a flow of processing performed by the weather management apparatus according to Embodiment 4.

FIG. 16 A diagram showing a flow of processing performed by the weather management apparatus according to Embodiment 4.

FIG. 17 A diagram showing functional blocks of a weather management system according to Embodiment 4 and the configuration of a network including the weather management system.

### MODE FOR CARRYING OUT THE INVENTION

Embodiments of the present invention are hereinafter described with reference to the accompanying drawings.

As described above, the weather radars including dual polarization weather Doppler radars allow determination of the category of precipitation particles within clouds and more accurate estimation of the intensity of precipitation. However, the result of analysis based on observation data acquired by such weather radars merely show “estimation” and may be different from the weather phenomenon which actually occurred at the observation site. Precipitation particles are classified into categories including wet snow, dry snow, ice crystals, drizzle, rain, graupel (“arare” in Japanese), hail (“hyo” in Japanese), and heavy rain. For example, it may happen that although an estimation is made as “this observation area may have had wet snow” from observation data, actually the observation area experienced the weather phenomenon of “graupel.”

To address this, the Japan Meteorological Agency tries to improve the accuracy of analysis based on observation data by means of weather phenomena actually observed at or near the observation site through the combined use of observation data from the weather radars with data from observation equipment including rain gauges across the country possessed by the Japan Meteorological Agency, Ministry of Land, Infrastructure, Transport and Tourism, and local governments.

Although sensor devices such as rain gauges and snow gauges can detect a high or low rainfall or snowfall, they cannot detect drizzle, wet or dry snow, or graupel or hail. Disdrometers (device for measuring size and speed of precipitation particles) can observe drizzle, rain, hail, or snow. However, the disdrometers are mostly used for the purpose of research and are not deployed at observations sites across the country where the Japan Meteorological Agency has installed Automated Meteorological Data Acquisition System (AMEDAS), In particular, graupel and hail infrequently occur and are rarely observed from the ground, and it is impractical to promote the deployment of disdrometers.

Such weather phenomena which cannot be observed or are not observed accurately by the observation equipment at the AMEDAS observation sites are not fed back effectively to analysis based on observation data from weather radars, thereby presenting difficulty in improving the accuracy of analysis based on observation data from weather radars.

In addition to the weather phenomena such as hail and graupel, tornados and gusts including whirlwinds also occur infrequently and are rarely observed from the ground. Although the possibility of occurrence of a tornado can be estimated from observation of occurrence of thunderclouds based on observation data from weather radars, such weather phenomena are difficult to observe in the observation equipment due to a low frequency of occurrence and a localized and narrow range of occurrence.

To overcome those difficulties, the present invention builds a new technique for matching observation results based on observation data acquired by a weather radar against an actual weather phenomenon to provide the true value (Ground Truth label) of the weather phenomenon corresponding to the observation data from the weather radar. Specifically, the present invention utilizes weather-related posted information posted to a Web server which receives posted information from terminals of posters.

The present invention also provides a weather management apparatus for classifying and analyzing observation data from a weather radar according to a predetermined criterion, wherein the criterion is changed based on the true value (Ground Truth label) of a weather phenomenon determined from posted information. For example, the criterion is lowered to prevent missed detection of occurrence of a predetermined weather phenomenon.

### Embodiment 1

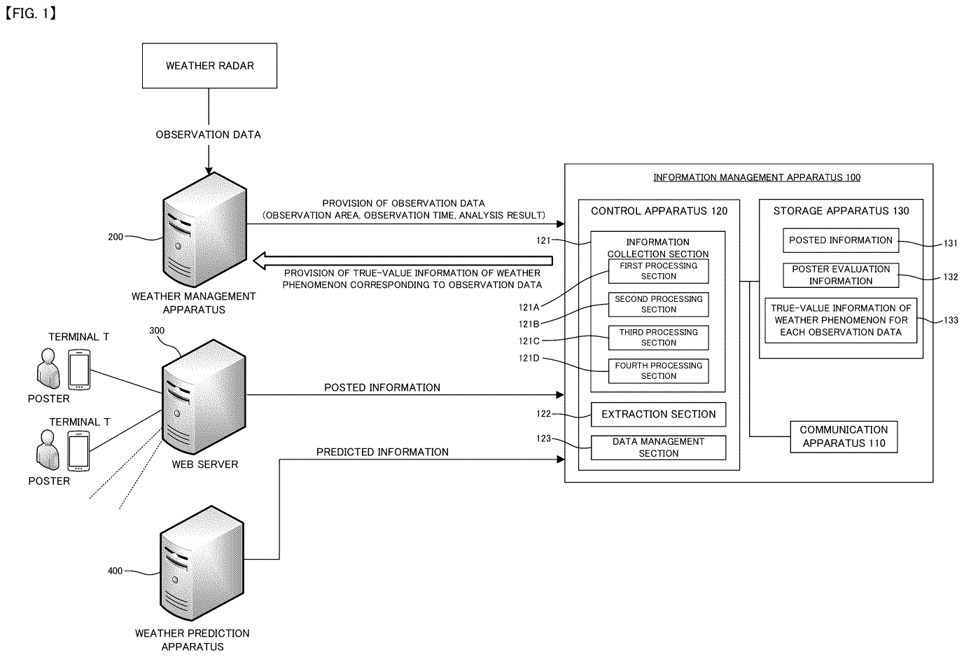

FIGS. 1 to 4 are diagrams for explaining Embodiment 1. FIG. 1 is a diagram showing functional blocks of an information management apparatus 100 according to Embodiment 1 and the configuration of a network including the apparatus 100.

The information management apparatus 100 is provided with information about observation data from a weather radar by a weather management apparatus 200 and is provided with posted information from posters by a Web server 300. The information management apparatus 100 provides a function of extracting a weather phenomenon found in weather-related posted information from posters that corresponds to the observation data acquired by the weather radar and creating the true value (Ground Truth label) of the weather phenomenon. In other words, the information management apparatus 100 serves as an apparatus for creating a dataset including the observation data and the Ground Truth label corresponding to that observation data.

The weather radar emits electromagnetic waves (microwaves) to observe rain and/or snow, for example. The weather radar can measure the distance to the rain and/or snow from the time for the emitted electromagnetic waves to return and can observe the intensity of rain and/or snow based on the intensity of the returned electromagnetic waves. As described above, dual polarization weather Doppler radars have been introduced and use horizontally vibrating electromagnetic waves and vertically vibrating electromagnetic waves (horizontally polarized waves and vertically polarized waves) to allow determination of the category of precipitation particles within clouds and estimation of the intensity of precipitation.

The dual polarization weather Doppler radar can estimate the shapes of precipitation particles from the ratio of amplitudes. Precipitation particles having larger size encounter greater air resistance and thus are more flattened. The precipitation particles are observed with the horizontally polarized waves and vertically polarized waves, and the shapes of them are estimated from the ratio of amplitudes of the reflected waves. In addition, the intensity of rain can be estimated from the phase difference. The electromagnetic waves have the characteristic of traveling slightly slower through water including raindrops than through the air without obstacles. By taking advantage of the characteristic of the horizontally polarized waves of traveling slower as they travel in heavier rain, the horizontally polarized waves and vertically polarized waves are used to observe rain, and the intensity of the rain is estimated from the phase difference of the reflected waves.

For the estimation of precipitation particles from the ratio of amplitudes, several categories are previously set including wet snow, dry snow, ice crystals, drizzle, rain, graupel, hail, and heavy rain. For example, when the ratio of amplitudes is equal to or higher a predetermined value, the precipitation particles are determined (categorized) as hail. The ratio of amplitudes is set as a criterion to estimate a weather phenomenon in an observation area based on observation data. Hail (Hailstones) are ice grains having a diameter of 5 mm or more falling from thunderclouds, whereas ice grains having a diameter less than 5 mm are defined as graupel.

The Web server 300 provides a Website which receives posted information from poster terminals T and publishes the received posted information on the Web. The posters are users who have registered on the Web server 300 and include a large number of unspecified posters. By way of example, information posted to Social Networking Services (SNS) such as Twitter® and Facebook® can be used. In this case, posted information other than the weather-related posted information is also accumulated on the Web server 300.

As another example, information posted to a specialized Website for receiving weather-related posted information can be used. For example, a poster serves as a weather reporter or an observer and posts daily weather information. In this case, only the weather-related posted information is accumulated on the Web server 300.

The information management apparatus 100 is connected to one or more Websites 300 to acquire weather-related posted information. The poster terminals T are mobile terminals including multi-functional mobile phones such as smartphones and tablet computers and have a data communication function over the Internet Protocol (IP) network or the Mobile Communication Network, a computing function (implemented by CPU, for example), and a storage apparatus (such as memory and auxiliary storage apparatus).

The poster terminal T can include a display control application such as a browser and also include an imaging apparatus for imaging still images and/or moving images, a display input apparatus of touch panel type, and a GPS apparatus. As later described, the posted information from the poster terminal T includes position information and time information acquired by the GPS apparatus together with the post content.

A weather prediction apparatus 400 provides a weather prediction function using a weather prediction model, for example, a Meso-Scale Model or Meso-Scale Weather Model WRF of the Japan Meteorological Agency to provide the result of prediction of a weather phenomenon (such as snow, rain, graupel, hail) in a prediction area at a prediction time. The weather prediction apparatus 400 (weather prediction model) is a known technology and detailed description thereof is omitted.

As shown in FIG. 1, the information management apparatus 100 is connected to the weather management apparatus 200, the Website 300, and the weather prediction apparatus 400 over the IP network or a dedicated network. A communication apparatus 110 controls data communication with each of the apparatuses. The information management apparatus 100 includes a control apparatus 120 and a storage apparatus 130. The control apparatus 120 includes an information collection section 121, an extraction section 122, and a data management section 123.

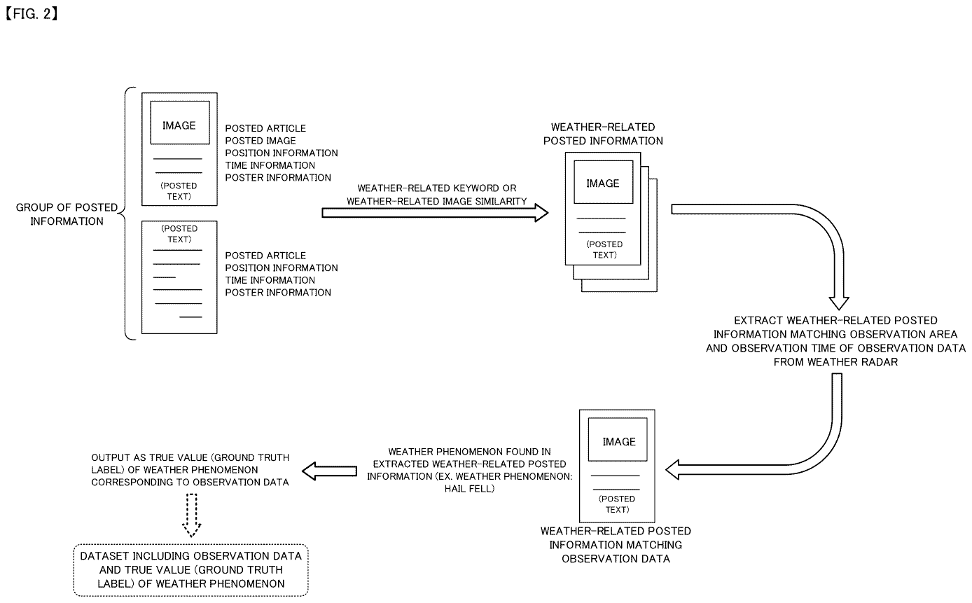

FIG. 2 is a diagram for explaining processing of creating true-value information linked to a weather phenomenon found in posted information that corresponds to observation data according to Embodiment 1.

Posted information posted to the Web server 300 includes a posted article and/or posted image, position information, time information, and poster information. The posted article is a posted text, and the posted image is an image taken by the imaging apparatus included in the poster terminal T or an image taken by an imaging apparatus different from that of the poster terminal T. The position information represents the current position of the poster (poster terminal T) and may include address information corresponding to the current position. The posted time represents information about date and time when the Web server 300 receives the posted information. The poster information represents a user identifier such as a user ID registered in the Web server 300.

The poster inputs an article and/or image through a post screen provided by the Web server 300 on the poster terminal T to transmit the information for posting to the Web server 300. The Web server 300 receives the posted information transmitted from the poster terminal T and puts and publishes the posted information on the post Website provided by the Web server 300.

While the posted information is acquired, that is, collected by the information management apparatus 100 from the Web server 300 which receives and publishes the posted information by way of example, the present invention is not limited thereto. For example, the posted information may be acquired via a search server (search site). The search site can collect posted information related to a search key such as a keyword from different post Websites (different Websites 300). The information management apparatus 100 can acquire the information posted to the Web server 300 from the Website 300 or from the search site capable of collecting the information posted to the Websites 300.

As shown in FIG. 2, the information collection section 121 acquires weather-related posted information from multiple pieces of posted information posted to the Web server 300 based on a weather-related keyword or a weather-related image similarity. One or more pieces of the weather-related posted information can be acquired. For example, the information collection section 121 can acquire, as the weather-related information, posted information including a keyword “hail” or posted information including a posted image similar to a reference image in which “hail” are imaged. While description is made with “hail” as an example, weather-related posted information regarding “graupel” can similarly be collected. It should be noted that an image recognition AI model can be used in processing of extracting posted information including any posted image related to “hail.” For example, it is possible to previously input a group of images in which “hail” are imaged as learning data and create an AI model for “recognizing images of hail” through learning processing. Then, the created AI model can be used to calculate a similarity of “hail” in a posted image. Posted information including a posted image having a similarity of a predetermined value or higher is acquired as the weather-related information.

Next, the extraction section 122 performs processing of matching against observation data from the weather radar. Specifically, the extraction section 122 extracts weather-related posted information that matches the observation area and the observation time of observation data from the weather radar.

For example, the extraction section 122 matches the results of analysis of observation data from the weather radar, that is, observation area and the observation time of hail determined in the precipitation particle estimation based on the ratio of amplitudes, against the position information and the post time of the weather-related posted information regarding “hail.” The extraction section 122 determines whether or not the position information and the post time of the weather-related posted information regarding “hail” are within a predetermined range sufficiently close to the observation area and the observation time, and extracts weather-related posted information regarding “hail” that lies within the sufficiently close predetermined range.

The data management section 123 links the weather-related posted information matching the observation data as a weather phenomenon corresponding to the observation data. In other words, the data management apparatus 123 outputs the weather phenomenon found in the weather-related posted information extracted by the extraction section 122 as a weather phenomenon corresponding to the observation data.

The data management section 123 can output the weather phenomenon found in the weather-related posted information as the true value (Ground Truth label) of the weather phenomenon corresponding to the observation data and serve as a data creation section which creates a dataset including the observation data and the true value (Ground Truth label) of the weather phenomenon. The dataset can be fed back to the weather management apparatus 200 as supervised learning data and can be used in analysis processing or analysis algorithms for observation data from the weather radar described above and in tuning of the criterion (threshold value) used for analysis processing. It should be noted that the observation data itself does not need to be held in the dataset as long as the true value (Ground Truth label) of the weather phenomenon can be linked to the corresponding observation data. By way of example, for feedback to the weather management apparatus 200, the information management apparatus 100 (data management section 123) can create and provide a dataset including the observation area and the observation time and the true value (Ground Truth label) of the output weather phenomenon.

The above example has been described with the estimation of precipitation particles in which the observation data determined as hail is matched against the weather-related posted information regarding “hail.” In another example, the observation area and the observation time of determined graupel are matched with the position information and the post time of the weather-related posted information regarding “hail,” and “hail” may be linked as the true value (Ground Truth label) of the weather phenomenon to the observation data including the observation area and the observation time of determined graupel, and vice versa.

As described above, the information management apparatus 100 according to Embodiment 1 verifies the weather phenomenon estimated from the results of analysis of the observation data by using the posted information which can be collected on the Web, and provides the weather phenomenon found in the weather-related posted information as the true value (Ground Truth label) of the weather phenomenon corresponding to the observation data.

In particular, for the weather phenomenon which occurs infrequently and is rarely observed from the ground such as hail or graupel, it can verify the results of analysis of the observation data to improve the accuracy of analysis based on the observation data from the weather radar.

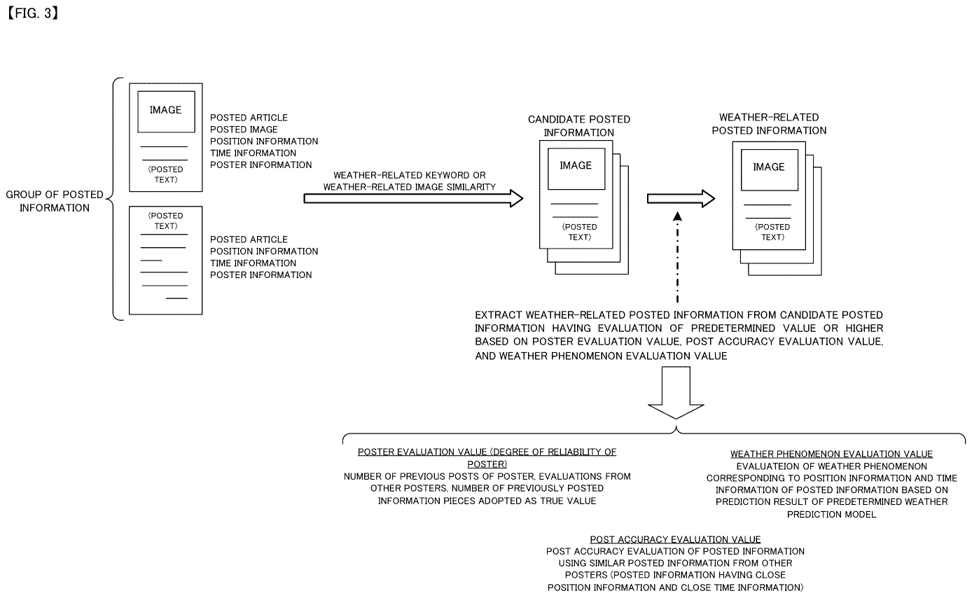

FIG. 3 is a diagram for explaining processing of extracting weather-related posted information from posted information using various types of evaluation information according to Embodiment 1.

The information collection section 121 can extract weather-related posted information from multiple pieces of posted information such that it evaluates accuracy of posted information and extracts weather-related posted information having an evaluation at a certain level or higher. The information collection section 121 can include first to fourth processing sections.

As shown in FIG. 3, the first processing section 121A of the information collection section 121 extracts candidate posted information from multiple pieces of information posted to the Web server 300 based on a weather-related keyword and a weather-related image similarity (first processing).

The second processing section 121B of the information collection section 121 creates a poster evaluation value of the poster of the candidate posted information based on a predetermined criterion (second processing). The poster evaluation value can be calculated with reference to evaluation parameters (criteria) including the number of previous posts of the poster, the number of evaluations from other posters, the number of pieces of previously posted information adopted as true values (Ground Truth labels), etc. The number of previous posts of the poster and the number of evaluations from other posters can be acquired from the posting history managed by the Web server 300. For the number of pieces of previously posted information adopted as true values (Ground Truth labels), posters of weather-related posted information adopted as true values (Ground Truth labels) can be accumulated in the information management apparatus 100. The number of pieces of previously posted information adopted as true values (Ground Truth labels) can be stored as poster evaluation information 132 in the storage apparatus 130.

The third processing section 121C of the information collection section 121 calculates the number of pieces of posted information from other posters similar to the candidate posted information extracted by the first processing section 121A as the post accuracy of that candidate posted information. Specifically, the third processing section 121C extracts, from multiple pieces of posted information posted to the Web server 300, the posted information (similar posted information) pieces from other posters that include position information and time information within a predetermined range close to the position information and the time information of the candidate posted information and that have a weather-related keyword or a weather-related image similarity. The third processing section 121C creates the post accuracy evaluation value of the candidate posted information based on the extracted similar posted information (third processing).

The fourth processing section 121D of the information collection section 121 evaluates the accuracy of the candidate posted information extracted by the first processing section 121A through the use of prediction information created by the weather prediction apparatus 400. Specifically, the fourth processing section 121D creates a weather phenomenon evaluation value of the candidate posted information based on prediction information created by a predetermined weather prediction model that corresponds to the position information and the time information of the candidate posted information (fourth processing). When the weather phenomenon in the position information and the time information of the candidate posted information are similar to the weather information of the prediction information, a high weather phenomenon evaluation value is calculated. When the weather phenomenon in the position information and the time information of the candidate posted information are different from the weather information of the prediction information, a low weather phenomenon evaluation value is calculated.

The information collection section 121 extracts the weather-related posted information from the candidate posted information that has an evaluation of a predetermined value or higher based on the poster evaluation value, the post accuracy evaluation value, and the weather phenomenon evaluation value. For example, the information collection section 121 can extract the candidate posted information having each evaluation value of a predetermined value or higher as the weather-related posted information, or can extract the candidate posted information having the sum of the evaluation values of a predetermined value or higher as the weather-related posted information. The information collection section 121 can add a weight value to the poster evaluation value, the post accuracy evaluation value, and the weather phenomenon evaluation value to calculate the sum of those evaluation values, for example such that a high weight value is set for the poster evaluation value and the post accuracy evaluation value and a low weight value is set for the weather phenomenon evaluation value. In this case, the weight values can be set arbitrarily.

Each of the poster evaluation value, the post accuracy evaluation value, and the weather phenomenon evaluation value can be set alone or in any combination. The information collection section 121 can evaluate the candidate posted information based on at least one or any combination of the poster evaluation value, the post accuracy evaluation value, and the weather phenomenon evaluation value to extract the weather-related posted information.

It should be noted that the processing of extracting the weather-related posted information using the evaluation values described above may not be performed depending on the characteristics of posted information. For example, when the weather-related posted information is collected from the Web server 300 (Website) for weather information posting which exclusively receives posts of weather information, those posts can be handled as posted information having guaranteed reliability of posters and guaranteed accuracy of posted information, so that the information management apparatus 100 does not perform selection based on the evaluation values. In other words, when the Web server 300 which receives posted information selectively publishes the posted information having guaranteed reliability of posters and guaranteed information accuracy on the Web, the candidate posted information extracted by the first processing section 121A can be provided as the weather-related posted information without additional selection.

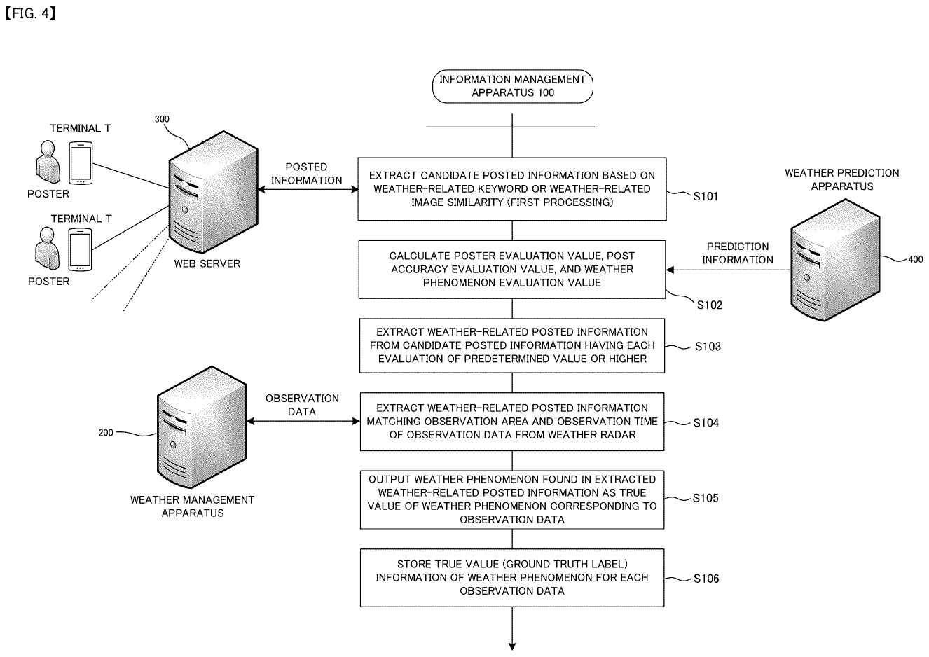

FIG. 4 is a diagram showing a flow of processing performed by the information management apparatus 100 according to Embodiment 1.

Posted information is accumulated on the Web server 300 from posters through the poster terminals T. The posted information includes information other than weather-related information.

The information management apparatus 100 extracts candidate posted information from multiple pieces of information posted to the Web server 300 based on a weather-related keyword or a weather-related image similarity (S101). For example, the information management apparatus 100 searches the posted information accumulated on the Web server 300 by using a keyword such as “hail” or “graupel,” or a sample image of “hail” or “graupel” as an extraction key. The extraction key is arbitrarily set on the operation side of the information management apparatus 100.

The candidate posted information is posted information associated with one of the weather-related keyword and the sample image, or posted information associated with both of the weather-related keyword and the sample image.

Next, the information management apparatus 100 performs the evaluation value calculation processing described in FIG. 3 on the extracted candidate posted information (S102). The information management apparatus 100 extracts weather-related posted information from one or more pieces of candidate posted information having at least one evaluation of a predetermined value or higher based on the calculated poster evaluation value, post accuracy evaluation value, and weather phenomenon evaluation value (S103). For example, the information management apparatus 100 can extract the weather-related posted information from the candidate posted information having the highest evaluation result based on the evaluation values.

The information management apparatus 100 acquires observation data from the weather management apparatus 200. The information management apparatus 100 extracts the weather-related posted information matching the observation area and the observation time of the observation data from the weather radar (S104). The information management apparatus 100 outputs the weather phenomenon found in the extracted weather-related posted information as the true value (Ground Truth label) corresponding to the observation data (S105). The output true value (Ground Truth label) of the weather phenomenon based on the posted information is stored in the storage apparatus 130 (S106).

As described above, the information management apparatus 100 can also serve as the data creation section which creates the dataset including the observation data and the true value (Ground Truth label) of the weather phenomenon. The information management apparatus 100 can provide the dataset for the weather management apparatus 200 or the weather prediction apparatus 400 at a desired time to help improved accuracy of the analysis processing of the weather management apparatus 200 or of the prediction processing of the weather prediction apparatus 400.

In the processing steps performed by the information management apparatus 100 described above, the matching processing mainly performed at step S104 includes two aspects.

In the first aspect, the information management apparatus 100 (control apparatus 120) can acquire, from the weather management apparatus 200, the observation data including the observation area and observation time that correspond to the position information and the time information of the weather-related posted information extracted at step S103, and perform the matching of them at step S104.

In the second aspect, the information management apparatus 100 can previously acquire observation data showing a particular weather phenomenon such as “hail” or “graupel” as an analysis result from the weather management apparatus 200, and the processing of extracting the weather-related posted information from steps S101 to S103 can include extracting weather-related posted information corresponding to the observation area and the observation time of the observation data.

The first and second aspects include matching the weather-related posted information collected from the Web server 300 and the observation data by the position information and the time information and extracting the weather-related posted information that matches the observation area and the observation time of the observation data from the weather radar to output the true value (Ground Truth label) of the weather phenomenon corresponding to the observation data.

### Embodiment 2

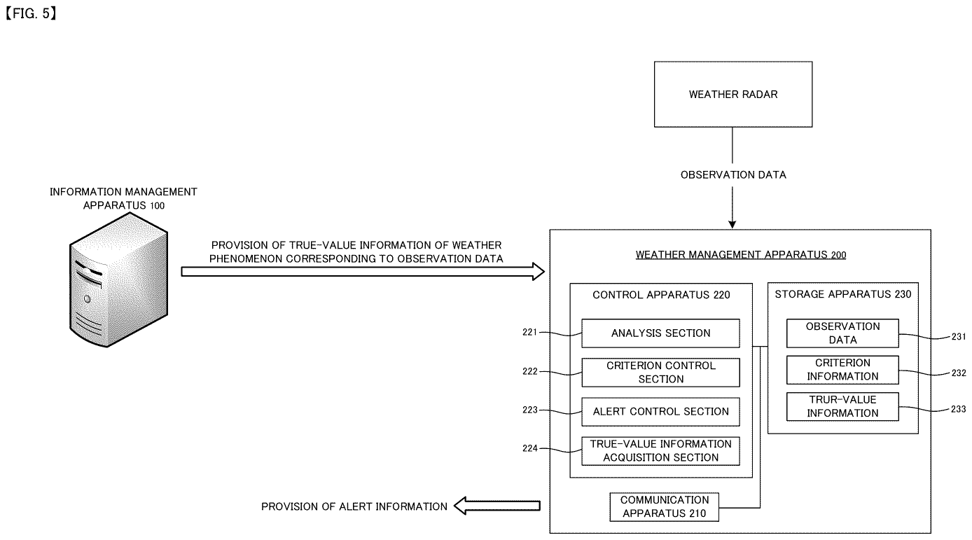

FIGS. 5 to 7 are diagrams for explaining Embodiment 2. In Embodiment 2, the weather management apparatus 200 provides a weather management function of analyzing observation data and outputting an alert based on the analysis result. In this processing, the true value (Ground Truth label) of the weather phenomenon corresponding to the observation data created by the information management apparatus 100 according to Embodiment 1 is fed back in real time. The weather management apparatus 200 according to Embodiment 2 cooperates with the information management apparatus 100 according to Embodiment 1 described above to constitute a weather management system.

FIG. 5 is a diagram showing functional blocks of the weather management apparatus 200 according to Embodiment 2 and the configuration of a network including the apparatus 200. The weather management apparatus 200 includes a communication apparatus 210, a control apparatus 220, and a storage apparatus 230. The control apparatus 220 includes an analysis section 221, a criterion control section 222, an alert control section 223, and a true-value information acquisition section 224.

The analysis section 221 classifies observation data from the weather radar according to a predetermined criterion and outputs the result of analysis based on the classification. As described above, the analysis section 221 can perform the precipitation particle estimation processing (analysis processing) using the ratio of amplitudes for the preset categories (classifications) including wet snow, dry snow, ice crystals, drizzle, rain, graupel, hail, and heavy rain. The analysis section 221 sets the ratio of amplitudes as the criterion and estimates the weather phenomenon in the observation area based on the observation data.

The alert control section 223 outputs alert information based on the result of analysis of the analysis section 221. For example, the alert control section 223 can output alert information to an information delivery system which has multiple registered users or a Web server which publishes information on a Website, or can provide alert information for users (user terminals) registered in the weather management apparatus 200.

Embodiment 2 includes the criterion control section 222 which changes the criterion based on the weather phenomenon (true value) found in the weather-related posted information corresponding to the observation data and output from the information management apparatus 100 according to Embodiment 1.

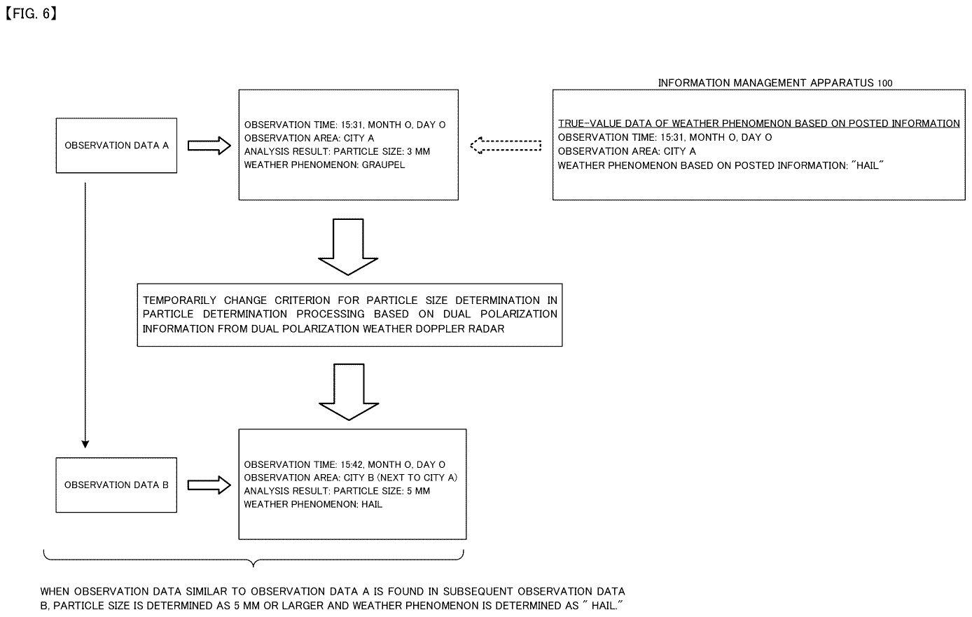

FIG. 6 is a diagram for explaining processing of changing the criterion according to Embodiment 1.

The weather management apparatus 200 performs the precipitation particle estimation processing using observation data A from the weather radar. The observation data A includes the observation time of 15:31 on Jan. 5, 2023, and the observation area of city A. The analysis section 221 outputs the particle size “3 mm” as the result of analysis of the observation data A according to the criterion. The analysis section 221 outputs the weather phenomenon “graupel” associated with the particle size “3 mm” and the analysis result. The alert control section 223 creates and outputs alert information, for example, “Graupel may be falling in city A. Watch out.”

The observation data A is also provided in real time for the information management apparatus 100 in parallel with the analysis processing of the weather management apparatus 200 to perform processing of creating the true value (Ground Truth label) of the weather phenomenon based on the weather-related posted information corresponding to the observation area and the observation time. The true value (Ground Truth label) is linked to the observation data A and is provided from the information management apparatus 100 to the weather management apparatus 200. The true-value information acquisition section 224 performs processing of providing the observation data A for the information management apparatus 100 and processing of acquiring the true value (Ground Truth label) from the information management apparatus 100.

Upon reception of the true value (Ground Truth label) linked to the observation data A, the criterion control section 222 performs processing of matching the analysis result against the true value (Ground Truth label). When the matching processing shows that the weather phenomenon from the analysis result is different from the true value (Ground Truth label) linked to the observation data A, the criterion control section 222 temporarily changes the criterion. In the example of FIG. 6, the analysis result indicates “graupel” and the true value (Ground Truth label) indicates “hail,” and they are different from each other. The criterion control section 222 determines that the weather phenomenon based on the observation data A is the true value (Ground Truth label) and changes the criterion.

For example, the criterion in the precipitation particle estimation processing determines “graupel” when the ratio of amplitudes is equal to or higher than a predetermined value X and is less than a predetermined value Y or determines “hail” when the ratio of amplitudes is equal to or higher than the predetermined value Y, and the analysis result of the weather phenomenon is output as “graupel” or “hail.” In the example of FIG. 6, the “graupel” is output as the analysis result since the ratio of amplitude in the observation data A is equal to or higher than the predetermined value X and is less than the predetermined value Y. In reality, however, “hail” was falling, so that the predetermined value Y serving as a threshold value between “graupel” and “hail” is changed into a predetermined value Y1. Since the predetermined value Y2 is smaller than the predetermined value Y, the change in threshold value widens the range in which the observation data is determined as “hail.”

As described above, the threshold value of the criterion is changed to temporarily narrow the range for determination as “graupel” and widen the range for determination as “hail.” Then, the changed criterion is used in analysis processing of observation data B acquired after the observation data A.

The observation data B includes the observation time of 15:42 on Jan. 5, 2023, and the observation area of city B (next to city A). The observation data B is similar to the observation data A, and the result of analysis according to the criterion before the change shows determination of “graupel.” After the criterion is changed with the true value (Ground Truth label) linked to the observation data A, the analysis section 221 outputs the weather phenomenon “hail” as the result of analysis of the observation data B. The alert control section 223 creates and outputs alert information, for example, “Hail may be falling in city B. Watch out,” or “Hail may fall soon in city B. Watch out.” Since the weather radar can observe precipitation particles in the sky above, the alert information may be output several minutes to several tens of minutes before the precipitation particles start to fall to the ground.

The change of the criterion can be performed for each observation area. For example, observation data C of an observation area far from the observation area of the observation data A can undergo analysis processing without changing the criterion. On the other hand, the changed criterion can be used in the analysis processing of the observation data B acquired in the observation area close to that of the observation data A and within a predetermined time period after the observation time of the observation data A.

As describe above, the criterion can be changed for each observation area and each observation time of observation data corresponding to the true value provided by the information management apparatus 100. The changed criterion value has an effective area and an effective period set therein. Specifically, the observation area subjected to processing according to the changed criterion is set to an area within a predetermined range of the observation area of the observation data A corresponding to the true value (Ground Truth label), and the effective period is set to a predetermined period (for example, 30 minutes) after the observation time of the observation data A. After the effective period, the changed value is initialized. Then, the criterion value before the change (default value) is used to perform analysis processing.

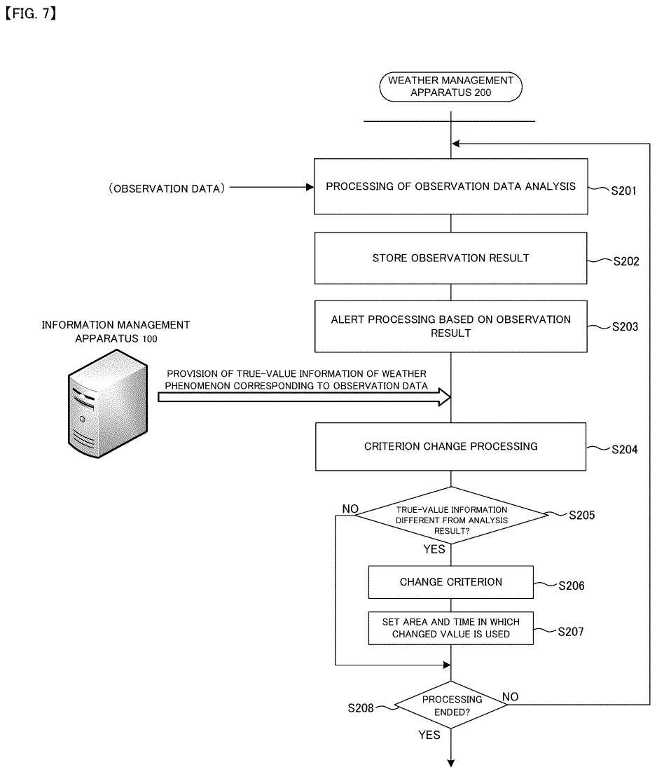

FIG. 7 is a diagram showing a flow of processing performed by the weather management apparatus 200 according to Embodiment 2.

The weather radar performs observation sequentially at predetermined intervals and outputs observation data. Upon input of the observation data A from the weather radar, the weather management apparatus 200 performs analysis processing of the observation data A (S201). In the processing, the weather management apparatus 200 provides the observation data A to be analyzed for the information management apparatus 100.

The weather management apparatus 200 performs the precipitation particle estimation processing described above. For example, the weather management apparatus 200 performs classification according to a predetermined criterion and outputs the result of analysis based on the classification. The analysis result is stored in the storage apparatus 230 (S202). The weather management apparatus 200 outputs alert information based on the analysis result (S203).

The weather management apparatus 200 receives true-value information of the weather phenomenon corresponding to the observation data A from the information management apparatus 100. Upon the reception of the true-value information from the information management apparatus 100, the weather management apparatus 200 starts processing of changing the criterion (S204). The weather management apparatus 200 compares the analysis result of the observation data A with the received true value (Ground Truth label) information, and when they are determined as indicating the same weather phenomenon, does not perform the criterion changing processing (NO at S205). Alternatively, when they are determined as indicating different weather phenomena (YES at S205), the weather management apparatus 200 changes the criterion based on the true value (Ground Truth label) found in the weather-related posted information corresponding to the observation data A (S206).

The weather management apparatus 200 uses the criterion changed at step S206 to repeatedly perform analysis processing of subsequent observation data from the weather radar (NO at S208 to S201).

As described above, the criterion control section 222 changes the criterion based on the weather phenomenon found in the weather-related posted information corresponding to the observation data A such that the effective area and the effective period subjected to processing according to the changed criterion are set based on the observation area and the observation time of the observation data A (S207). At step S201, the analysis section 221 determines whether or not the observation area and the observation time of the subsequent observation data B are within the effective range corresponding to the set effective area and effective period, and when they are determined as being within the effective range, uses the changed criterion in the analysis processing of the subsequent observation data B.

In Embodiment 2, the true value (Ground Truth label) provided in real time by the information management apparatus 100 is used for the analysis processing of the observation data in the weather management apparatus 200 and is reflected in the analysis processing of the subsequent observation data. Specifically, when the analysis result of the observation data is different from the true value (Ground Truth label) found in the weather-related posted information, the criterion is changed based on the true value (Ground Truth label) to provide more accurate analysis results of subsequent observation data.

Hail are a natural disaster which may cause significant damage. When the analysis result of the observation data shows that graupel are falling instead of hail, hail may be actually falling (in posted information). In the analysis processing of subsequent observation data, a severe determination of hail is made even when the subsequent observation data is similar to the previous data providing the determination of graupel. In other words, hail are determined more frequently to reduce missed determinations of hail. Such a configuration allows more alerts to be issued for the weather phenomenon which is a natural disaster causing significant damage, thereby properly raising awareness of disaster prevention.

The area and time range subjected to processing according to the changed criterion is set with reference to the observation area and the observation time of the observation data which triggered the change of the criterion. Hail are a special weather phenomenon which is observed infrequently as described above and does not last for a long time over a wide range. Thus, the changed criterion is applied to the observation data acquired within a radius of 50 km from the observation area of the observation data which triggered the change of the criterion and within two hours after that observation data, allowing more alerts to be issued for the weather phenomenon which is a natural disaster causing significant damage. Such a configuration can appropriately limit the area where the alert of hail is output and can reduce confusions due to the alert without unnecessarily widening the area where the alert of hail is output.

### Embodiment 3

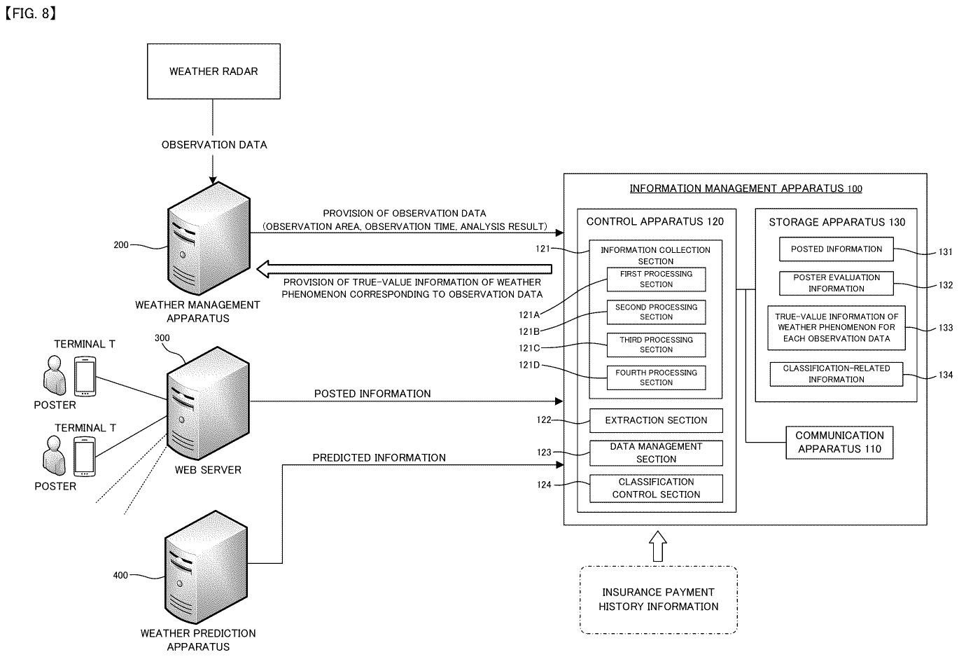

FIGS. 8 to 12 are diagrams for explaining Embodiment 3. Embodiment 3 differs from Embodiment 1 described above in that the former has a function of classifying weather-related posted information according to an insurance payment history. The components similar to those in Embodiment 1 are designated with the same reference numerals in those figures and description thereof is omitted.

FIG. 8 is a diagram showing functional blocks of the information management apparatus 100 according to Embodiment 3 and the configuration of a network including the apparatus 100. The control apparatus 120 of the information management apparatus 100 further includes a classification control section 124, and the storage apparatus 130 has classification-related information 134 stored therein.

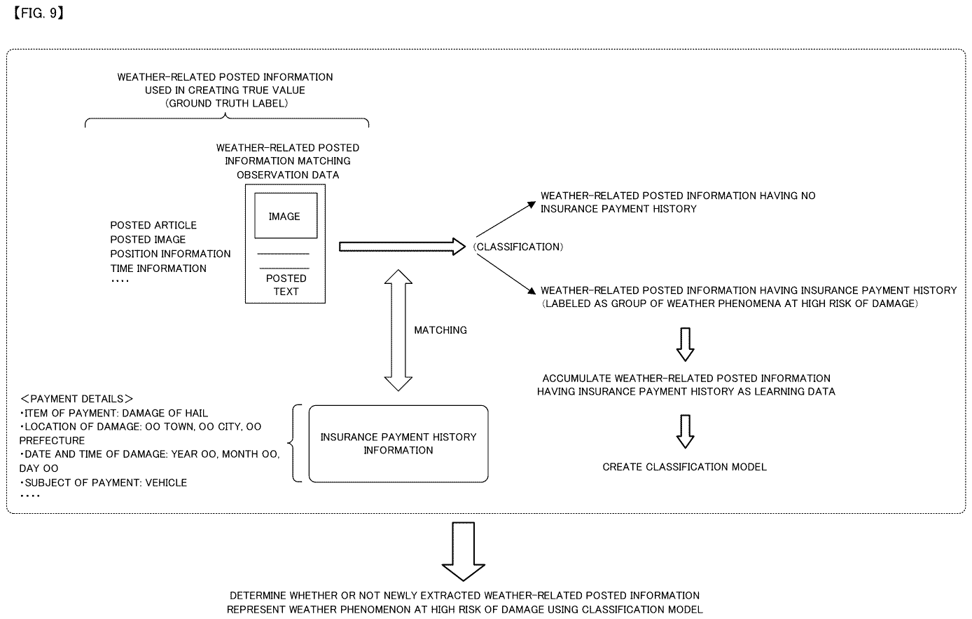

FIG. 9 is a diagram for explaining a first function of classifying weather-related posted information based on an insurance payment history and a second function of classifying weather-related posted information using a classification model according to Embodiment 3. The first function includes creating learning data from the previous weather-related posted information and using the created learning data to create the classification model. The second function includes using the created classification model to perform classification determination processing on the weather-related posted information newly extracted by the extraction section 122 and associating the result of the classification determination processing with a weather phenomenon corresponding to observation data output from the data management section 123, that is, the true value (Ground Truth label).

The insurance payment history is a history of actual payments of insurance from insurance products provided by insurance companies against damage due to weather phenomena including hail, graupel, tornados, and whirlwinds. The insurance products include individual insurance products covering natural disasters such as fire insurances, water damage insurances, earthquake insurances, and vehicle insurances, and business insurance products covering natural disasters.

The history of insurance payments represents records of insurance payments made by insurance companies which assessed damage situations in response to claims from insurance policyholders and includes information such as the item of payment, location of damage, date and time of damage, and subject of payment.

The item of payment indicates a weather phenomenon related to occurrence of damage, and for example, includes “damage from hail.” The location of damage indicates a location (position information about the occurrence of damage) where hail fell to cause damage to the subject of payment, and for example, includes address information “OO town, OO city, OO prefecture.” The subject of payment indicates a damaged asset and represents insurance coverage. For example, the subject of payment of a vehicle insurance is a vehicle, or the subject of payment of a fire insurance is a house. The insurance payment history information is provided by insurance companies. The insurance payment history information can be acquired from insurance companies through networks (from servers or terminals of insurance companies) or can be acquired in the form of a physical list and input to the information management apparatus 100 by an administrator. The insurance payment history information is stored as the classification-related information 134 in the storage apparatus 130.

In Embodiment 3, the insurance payment history information is used to classify weather-related posted information into a group of weather phenomena at high risk of damage (group of weather phenomena having records of insurance payments) and a group of the other weather phenomena (group of weather phenomena having no records of insurance payments). Specifically, weather-related posted information provided at the location of damage and on the date and time of damage in the insurance payment history is extracted from multiple pieces of weather-related posted information and associated with information indicating a weather phenomenon at high risk of damage. This can separate the weather phenomenon at high risk of damage based on the insurance payment history (records) from the information representing the same weather phenomenon. For example, weather-related posted information belonging to the weather phenomenon “hail” can be classified into pieces of weather-related posted information belonging to the weather phenomenon “hail (at high risk of damage)” and the other pieces of weather-related information.

The classification control section 124 associates (labels) the weather-related posted information provided at the location of damage and on the date and time of damage in the insurance payment history with classification information “high risk of damage.” The data management section 123 can control creation of the true value (Ground Truth label) such that it includes the classification information associated with the weather-related posted information used in creating the true value (Ground Truth label). For example, the true-value information 133 of the weather phenomenon for each observation data stored in the storage apparatus 130 can include the classification information “high risk of damage” in addition to the observation time, observation area, and weather phenomenon based on weather-related posted information.

As described above, the hail are ice grains having a diameter of 5 mm or larger, and an ice grain having a diameter of 10 mm is classified similarly as the hail. Ice grains having larger diameters may cause more serious damage, whereas ice grains having smaller diameters may cause less serious damage. Since the same weather phenomenon, hail, may lead to different levels of damage, Embodiment 3 employs the insurance payment history information (damage records) to show evidence of actual damage caused by the weather phenomenon “hail.”

The weather-related posted information associated with the insurance payment history (weather-related posted information used for creating the true value (Ground Truth label)) is accumulated as learning data. The learning data is stored as the classification-related information 134 in the storage apparatus 130.

For example, images and/or posted texts of the weather-related posted information associated with the insurance payment history can be accumulated as learning data. The images are used as learning data in image form showing hail which caused actual damage, and the posted texts are used as learning data in text form (such as keywords) describing hail which caused actual damage. For example, posted texts including keywords directly related to hail or keywords related to damage caused by hail are used as learning data, such as “diameter of at least 30 mm,” “as large as golf balls,” “bonnet got dented,” or “they broke through the garage roof.”

The accumulated learning data is used for processing of creating the classification model (learning processing) which determines whether or not newly extracted weather-related posted information represents a weather phenomenon at high risk of damage. The classification model calculates the similarity of an image and/or the similarity of a posted text based on keywords in newly extracted weather-related posted information and classifies weather-related posted information having a similarity equal to or higher than a predetermined value into a group of weather phenomena at high risk of damage.

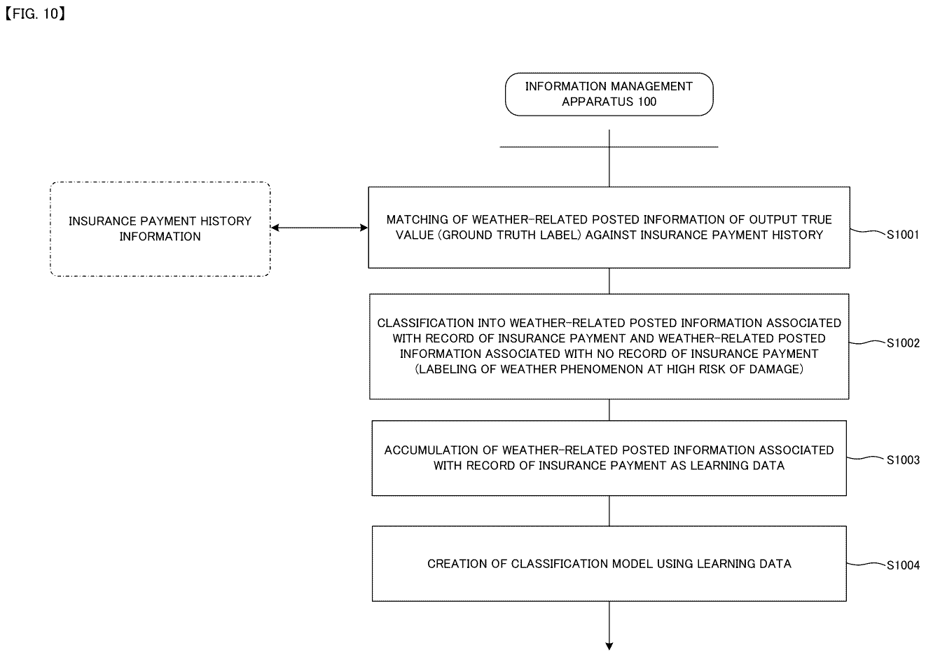

FIG. 10 is a diagram showing a flow of processing of the first function performed by the classification control section 124. The classification control section 124 performs the following processing:
1) first processing of classifying the past weather-related posted information extracted by the extraction portion 122 into a group of weather phenomena at high risk of damage based on the insurance payment history information including the location of damage resulting in insurance payment, the date and time of occurrence of damage, and the weather phenomenon related to the occurrence of damage (S1001, S1002);
2) second processing of storing the weather-related posted information classified into the group of weather phenomena at high risk of damage in a predetermined storage region as learning data (S1003); and
3) third processing of using the learning data to create a classification model for classifying weather-related posted information to be extracted later by the extraction section 122 into a weather group at high risk of damage (S1004).

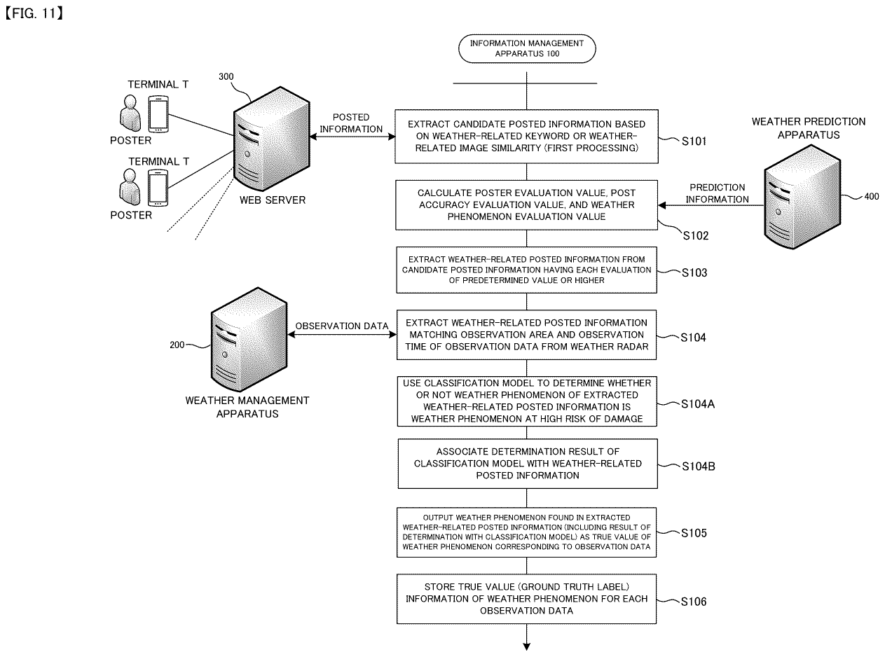

FIG. 11 is a diagram showing a flow of processing performed by the information management apparatus 100 and similar to the flow of processing in FIG. 4 according to Embodiment 1 described above. In FIG. 11, steps S104A and S104B are added and correspond to the second function provided by the classification control section 124.

The classification control section 124 performs the following processing on the weather-related posted information extracted at step S104:
4) fourth processing of performing classification determination by using the created classification model to determine whether or not weather-related posted information extracted by the extraction section 122 belongs to the group of weather phenomena at high risk of damage (S104A); and
5) fifth processing of associating the result of the classification determination with the weather phenomenon (true value (Ground Truth label)) corresponding to observation data output from the data management section 123 (S104B).

The result of classification determination with the classification model (identification information representing a weather phenomenon at high risk of damage) is added to the true value (Ground Truth label) output from the data management section 123. In other words, the true value (Ground Truth label) output from the data management section 123 is configured to include information representing whether or not the weather phenomenon belongs to the group of weather phenomena at high risk of damage.

Next, description is made of a case in which the true value (Ground Truth label) including the identification information representing “weather phenomenon at high risk of damage” in Embodiment 3 is applied to Embodiment 2 described above.

As shown in FIG. 6, according to Embodiment 2, the criterion can be changed by using the true value (Ground Truth label) provided from the information management apparatus 100. Similarly, according to Embodiment 3, the weather management apparatus 200 can change the criterion by using the true value (Ground Truth label) including the identification information representing “weather phenomenon at high risk of damage” provided from the information management apparatus 100 regardless of whether the associated weather phenomenon is “weather phenomenon at high risk of damage” or not.

The weather management apparatus 200 can also perform control such that the amount of criterion change when the true value (Ground Truth label) belongs to “weather phenomenon at high risk of damage” is different from that when the true value (Ground Truth label) does not belong to “weather phenomenon at high risk of damage.” For example, the criterion is changed into a changed value P1 based on the true value (Ground Truth label) belonging to “weather phenomenon at high risk of damage” (S206), whereas the criterion is changed into a change value P2 smaller than the changed value P1 (P1>P2) based on the true value (Ground Truth label) belonging to “weather phenomenon at high risk of damage.”

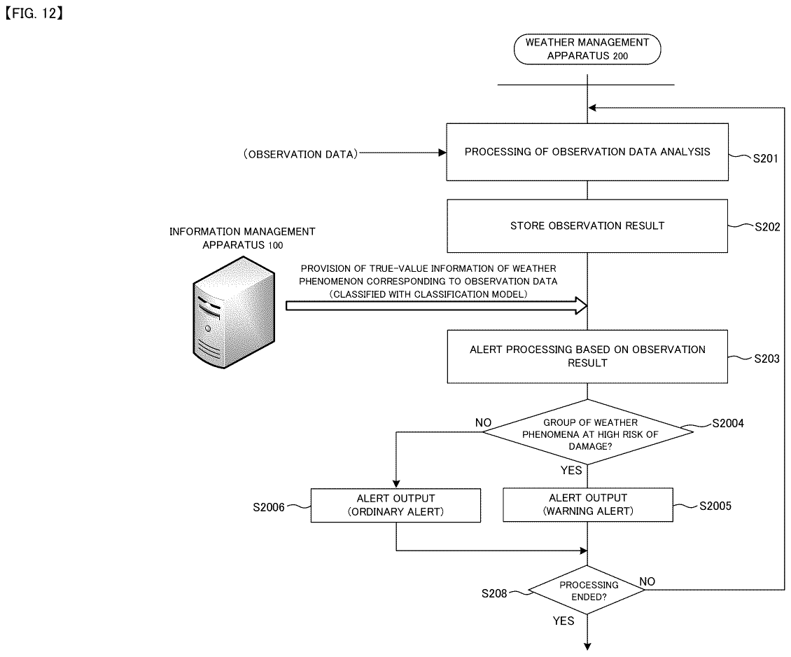

As shown in FIG. 12, the alert control section 223 of the weather management apparatus 200 determines whether or not the true value (Ground Truth label) provided from the information management apparatus 100 belongs to “weather phenomenon at high risk of damage” (S2004). When the true value is determined as belonging to “weather phenomenon at high risk of damage” (YES at S2004), the alert control section 223 can control alert output to provide alert information (for example, a warning alert) indicating that the true value represents the weather phenomenon which had a report of actual damage in the past (S2005). Alternatively, when the true value is determined as not belonging to “weather phenomenon at high risk of damage” (NO at S2004), the alert control section 223 can control alert output to provide ordinary alert information (S2006).

As described above, in the alert output processing, the special alert for a high risk of damage can be output to indicate the weather phenomenon resulting in actual damage in the past. For example, this can strongly recommend indoor evacuation against falling hail or against possible hail.

In addition, the alert control section 223 can perform control such that the alert information is output to different targets when the true value belongs to the group of weather phenomena at high risk of damage and when it does not belong to that group. As described above, in Embodiment 2, the alert information can be output to the information delivery system which has multiple registered users or the Web site which publishes information on a Website. For example, when the true value belongs to “weather phenomena at high risk of damage,” the alert control section 223 determines the urgency and provides the alert information directly for the terminals of the users registered on the information delivery system. Alternatively, when the true value does not belong to “weather phenomena at high risk of damage,” the alert control section 223 can output the alert information to the information delivery system or Web server such that the terminals of the users receive the alert information via the information delivery system or Web server. It should be noted that, even when the true value belongs to “weather phenomena at high risk of damage,” the alert control section 223 may provide the alert information representing “weather phenomenon at high risk of damage” for the information delivery system or Web server without changing the output target, and then the information delivery system or server may provide the alert information for the terminals of the users.

As described above, the information management apparatus 100 according to Embodiment 3 classifies the weather-related posted information for use in creating the true value (Ground Truth label) into the group of weather phenomena at high risk of damage and the group of the others based on the insurance payment history. In other words, the multiple pieces of weather-related posted information (the true value (Ground Truth label)) are classified according to the degree of risk based on the insurance payment history. For example, different degrees of risk can be distinguished among the pieces of weather-related information used in creating the true value (Ground Truth label) of the same weather phenomenon “hail.” As a result, feedback data for each degree of risk can be utilized in analysis based on observation data from the weather radar to further improve the accuracy of analysis.

The information management apparatus 100 according to Embodiment 3 accumulates, as learning data, the weather-related posted information classified into the group of “weather phenomena at high risk of damage” based on the insurance payment history, and uses the learning data to create the classification model for determining “weather phenomena at high risk of damage.” When Embodiment 3 is applied to Embodiment 2 described above, the weather management apparatus 200 can provide different alert outputs depending on the classification determination result of “weather phenomena at high risk of damage” added to the true value (Ground Truth label) and can perform control to use different changed values of the criterion depending on the degree of risk. This allows the weather management apparatus 200 to properly raise awareness of disaster prevention in real time.

For example, when hail at a high degree of risk fall, they may damage car bonnets or food crops. If the occurrence of them is known in advance, even immediately before, damage may be reduced by taking actions such as moving cars under roofs or covering food crops with sheets. This also applies to weather phenomena other than hail. For example, if the occurrence of a gust is known in advance, damage may be prevented by stopping the operation of trains, closing highways, or stopping works in high places. Although an ordinary alert output is an effective way to encourage actions to prevent damage, an alert output indicating a high degree of risk for the weather phenomenon causing the past actual damage can be used as a means for strongly recommending actions to prevent damage.

The encouragement of actions to prevent damage also has the following advantages in terms of insurance contract. Specifically, an insurance company which provides insurance products covering damage notifies insurance contractors of the alert information and allows them to take actions to reduce damage, so that the insurance contractors can prevent damage and the insurance company can reduce insurance payments, which is beneficial for both of them.

While Embodiments 1 to 3 have been described, the information management apparatus 100 can provide the true value (Ground Truth label) of weather phenomena other than hail and graupel, for example, a tornado and a whirlwind. In this case, weather-related posted information is posted information about hail, graupel, tornado, or whirlwind, and the information collection section 121 can acquire weather-related posted information including a tornado and whirlwind as a keyword and/or a similar image from the Web server 300. The extraction section 122 extracts weather-related posted information that matches the observation area and the observation time of observation data representing a tornado or a whirlwind from the weather radar. The data management section 123 can output the weather phenomenon of tornado or whirlwind found in the extracted weather-related posted information as a weather phenomenon corresponding to the observation data.

One of approaches to observation of tornados and whirlwinds is observation performed by a weather Doppler radar. In addition to measurement of the position or intensity of precipitation, the Doppler effect of electromagnetic waves reflected from precipitation particles carried by the wind can be used to measure wind components approaching the weather radar and wind components moving away from the weather radar. This is called the Doppler speed. When the approaching speed is equal to or higher than a predetermined value and the moving away speed is equal to or higher than a predetermined value, the occurrence of swirling wind (rotation within well-developed thunderclouds causing a tornado; mesocyclone) is determined. For example, when the Doppler speed is equal to or higher than a predetermined value, the occurrence of a tornado can be determined.

The weather management apparatus 200 can acquire observation data regarding the Doppler speed from the weather Doppler radar to perform analysis processing of determining whether or not a tornado or a whirlwind occurs. The weather management apparatus 200 can provide the observation data regarding the Doppler speed for the information management apparatus 100.

The weather prediction apparatus 400 according to Embodiment 1 can use a weather prediction model (prediction algorithm) with Energy-Helicity Index (EHI) for tornados and whirlwinds. In this case, the fourth processing section 121D of the information collection section 121 can create a weather phenomenon evaluation value of candidate posted information based on prediction information created by the weather prediction model for tornados and whirlwinds that corresponds to the position information and time information of the candidate posted information. In view of the weather phenomenon evaluation value, the information collection section 121 can extract weather-related posted information from the candidate posted information (extract weather-related posted information from the candidate posted information having an occurrence prediction evaluation value for tornados and whirlwinds equal to or higher than a predetermined value). Any known approach other than the EHI can be used in the weather prediction model for tornados and whirlwinds.

The weather management apparatus 200 according to Embodiment 2 can perform various types of processing including output of alert information and change of the criterion for tornados and whirlwinds. In the change of the criterion, the weather management apparatus 200 can change the threshold value of the Doppler speed used to determine the occurrence of a tornado based on the true value (Ground Truth label) provided by the information management apparatus 100. The functions of classification control section 124 according to Embodiment 3 can be configured to support tornados, whirlwinds, and gusts. In this case, the weather phenomena related to occurrence of damage in the insurance payment history information include tornados, whirlwinds, and gusts.

It should be noted that each of the apparatuses 100 and 200 according to Embodiments 1, 2, and 3 may be configured to cover one of hail, graupel, tornados, and whirlwinds, or cover all or any combination of hail, graupel, tornados, and whirlwinds.

### Embodiment 4

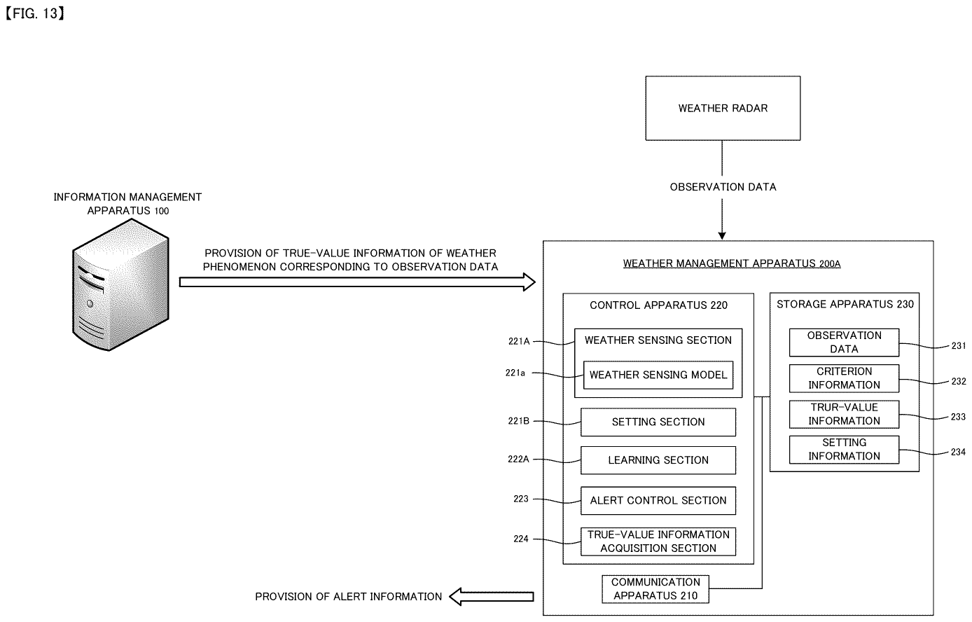

FIGS. 13 to 17 are diagrams for explaining Embodiment 4. Embodiment 4 includes a mechanism for enhancing the analysis function (weather sensing function) of the weather management apparatus 200 according to Embodiment 2 by using the weather-related posted information (true-value information) provided by the information management apparatus 100 according to Embodiment 1. The components similar to those in Embodiment 2 are designated with the same reference numerals in those figures and description thereof is omitted.

FIG. 13 is a diagram showing functional blocks of a weather management apparatus 200A according to Embodiment 4 and the configuration of a network including the apparatus 200A. Although this configuration is essentially the same as that in FIG. 5, the analysis section 221 is configured as a weather sensing section 221A including a weather sensing model 221a. The weather sensing model 221a performs processing of determining the category of precipitation particles within clouds in the sky indicated by observation data according to the criterion and performs weather sensing processing of outputting the category of precipitation particles falling to the ground based on the result of the category determination processing.

Specifically, the weather sensing model 221a (analysis section 221) performs the processing of determining the category of precipitation particles based on the ratio of amplitudes observed by the weather radar, and classifies the precipitation particles into categories including wet snow, dry snow, ice crystals, drizzle, rain, graupel, hail, and heavy rain according to the ratio of amplitudes. Each category of precipitation particles has a criterion set therefor. The weather sensing model 221a determines which category the ratio of amplitude observed by the weather radar belongs to and determines the category of one or more precipitation particles present within clouds in the sky. The weather sensing model 221a outputs the category of precipitation particles falling to the ground based on the result of the processing of determining the category of precipitation particles within clouds in the sky.

The information output from the weather sensing section 221A can be configured to include the category (for example, hail) of precipitation particles falling to the ground determined by the weather sensing model 221a, and the location and time corresponding to the observation area and the observation time of the observation data. The weather sensing section 221A can be configured to output, as the location, the region determined from the latitude and longitude of the observation area (for example, OO town, OO city, OO prefecture) based on map information.

The weather sensing section 221A can also be configured to output information representing the degree of reliability of the sensed weather phenomenon together with the location and time. The degree of reliability is described later.

The criterion control section 222 is configured as a learning section 222A for the weather sensing model 221a. The learning section 222A creates the weather sensing model 221a and uses the weather phenomenon found in the weather-related posted information as learning data (Ground Truth label) to perform learning processing (tuning processing) of learning the category of precipitation particles that actually fell to the ground corresponding to the category of precipitation particles in the sky indicated by the observation data and changing the criterion.

The weather management apparatus 200A according to Embodiment 4 can be configured to include a setting section 221B for setting priorities of categories of precipitation particles. Precipitation particles of different categories are present within clouds in the sky, and for example, observation data can be used to find the distribution of a hail area, a graupel area, a snow area, and a rain area within the clouds in the sky. In other words, precipitation particles of different categories are present three-dimensionally (with the latitude, longitude, and altitude) within the clouds in the sky.

The category of precipitation particles actually falling to the ground needs to be treated two-dimensionally (with the latitude and longitude). In Embodiment 4, the setting section 221B performs control to set the priorities of the respective categories of precipitation particles. The weather sensing model 221a determines the category of precipitation particles in the sky present within the observation area of observation data and outputs the category of precipitation particles falling to the ground in descending order of the set priorities. By way of example, the priorities may be set in the descending order of hail, graupel, snow, and then rain. When precipitation particles of two categories including “hail” and “graupel” are sensed, the weather sensing model 221a can output “hail” having a higher priority as the category of precipitation particles falling to the ground.

While description is made of the output control with the priorities set by the setting section 221B, the present invention is not limited thereto. For example, control can be performed to output only “hail” which is a natural disaster possibly causing large damage. In other words, the weather sensing model 221a can be configured to output the category of precipitation particles falling to the ground when a particular weather phenomenon is sensed. It should be noted that the setting of priorities can be changed at any time. For example, during weather sensing processing, a higher priority is given to snow than hail to perform switching such that “snow” is preferentially output as precipitation particles thereafter.

As described above, the weather management apparatus 200A according to Embodiment 4 includes the communication apparatus 210, the control apparatus 220, and the storage apparatus 230, and the control apparatus 220 includes the weather sensing section 221A including the weather sensing model 221a (corresponding to the analysis section 221), the setting section 221B, and the learning section 222A (corresponding to the criterion control section 222), the alert control section 223, and the true-value information acquisition section 224.

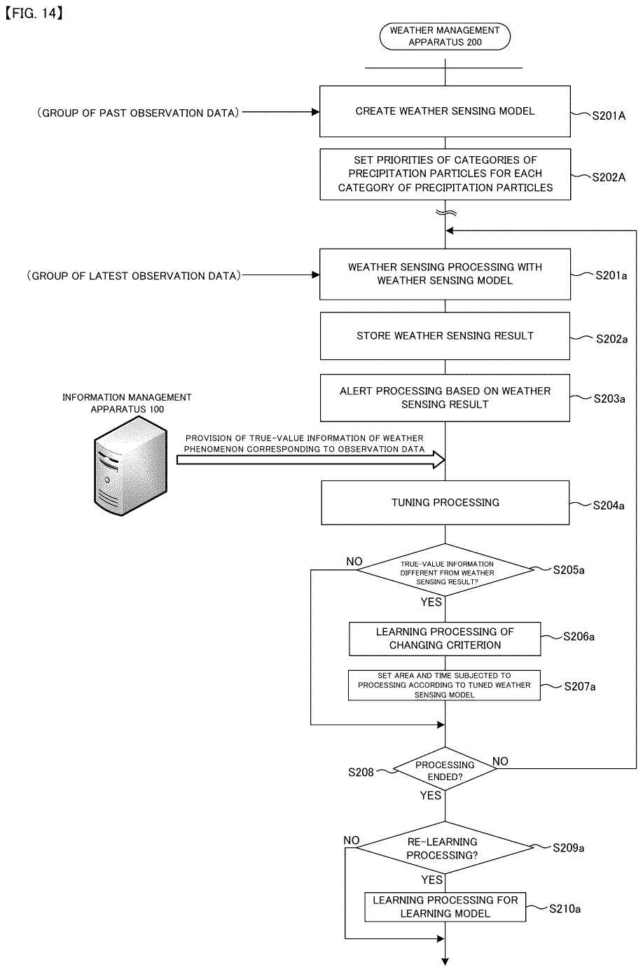

The weather sensing model 221a and the learning section 222A are now described. FIG. 14 is a diagram showing a flow of processing performed by the weather management apparatus 200A. FIG. 14 is similar to FIG. 7 in Embodiment 2 and shows a flowchart adapted to the processing of Embodiment 4. Steps S201a to S207a correspond to steps S201 to S207 in FIG. 7.

The weather sensing model 221a is a functional section which receives sequential input of observation data from the weather radar, and based on the input observation data, determines and outputs a current weather phenomenon (category of precipitation particles falling to the ground) (S201a). The weather sensing section 221A stores the output result of weather sensing in the storage apparatus 230 (S202a), and the alert control section 223 performs alert output processing (S203a). In the example of FIG. 14, the setting section 221B has performed processing of setting priorities in advance (S202A).

The learning section 222A performs the learning processing with learning data to create the weather sensing model 221a (S201A). The learning data includes observation data associated with weather-related posted information set as the Ground Truth label and is information including a set of the past observation data from the weather radar and the weather-related posted information corresponding to that observation data. In the example of FIG. 13, the learning data corresponds to observation data 231 and true-value information 233 and is stored in the storage apparatus 230.

The learning section 222A performs first learning processing (step S201A) of using the accumulated past learning data to create the weather sensing model 221a and second learning processing of tuning (adjusting) the weather sensing model 221a created in the first learning processing. The second learning processing includes processing of tuning (adjusting) the criterion for classifying observation data into multiple categories of precipitation particles to update the weather sensing model 221a or create individual weather sensing models 221a which use different criteria, as later described.

The second learning processing is divided into real-time processing (step S206a) performed in real time at the time of input of weather-related posted information (true-value information) and batch processing (S210a) of suspending the second learning processing at the time of input of weather-related posted information and performing the second learning processing at a predetermined time. The tuning method includes a first tuning method of performing only the real-time processing, a second tuning method of using the real-time processing and the batch processing in combination, and a third tuning method of performing only the batch processing.

In the second tuning method, the criterion is tuned in real time by performing the second learning processing at the time of input of weather-related posted information (true-value information) during the weather sensing processing of the weather sensing model 221a (S206a). At any time while the weather sensing processing is not performed, for example, during a maintenance period, the criterion is re-tuned (re-learning processing) to update the weather sensing model 221a by using multiple observation data items and multiple pieces of weather-related posted information accumulated since the previous maintenance period (S210a). FIG. 14 shows the processing flow of the second tuning method.

The first tuning method does not perform the second learning processing with batch processing but performs tuning through the second learning processing during the weather sensing processing similarly to the second tuning method. When the weather phenomenon found in the observation data is different from the weather phenomenon found in the weather-related posted information, the criterion can be changed in real time by setting the weather-related posted information as the Ground Truth label. This allows the tuned criterion to be used in weather sensing processing for subsequent observation data.

In contrast, the weather sensing model 221a is not updated in real time in the third tuning method. When the weather phenomenon found in the observation data is different from the weather phenomenon found in the weather-related posted information, the weather-related posted information corresponding to the previous observation data is not reflected as the Ground Truth label in the result of determination of the subsequent observation data output from the weather sensing section 221A (category of precipitation particles falling to the ground). To address this, the third tuning method takes a temporary measure until the second learning processing. The temporary measure includes replacement processing in which the category of precipitation particles output from the weather sensing model 221a is replaced with the weather phenomenon (Ground Truth label) found in the weather-related posted information corresponding to the previous observation data.

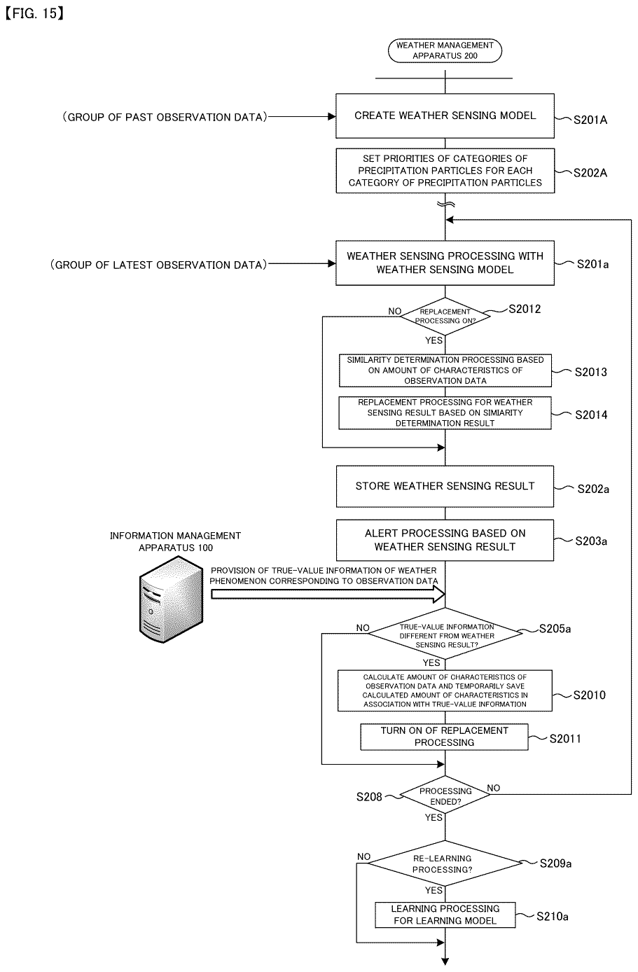

FIG. 15 is a diagram showing a flow of processing in the third tuning method. The weather sensing section 221A determines whether or not the category of precipitation particles output from the weather sensing model 221a based on observation data is different from the weather phenomenon found in the corresponding weather-related posted information (S205a). When they are determined as different weather phenomena (YES at S205a), the weather sensing section 221A temporarily holds the amount of characteristics of the observation data and the weather phenomenon found in the weather-related posted information (S2010), and turns a replacement processing flag ON (S2011). The amount of characteristics refers to information representing the weather condition found in observation data, for example, the weather condition within clouds in the sky such as the distribution range of precipitation particles of each category or the altitude at which precipitation particles are present. The amount of characteristics extracted from observation data can be calculated with a known method, and for example, the amount of characteristics can be represented by vectors of parameters representing the weather condition.

When the weather sensing processing of the subsequent observation data is performed and the category is determined, the weather management apparatus 200 checks whether the replacement processing flag is ON at step S2012. When the replacement processing flag is ON, the control proceeds to step S2013 to determine a similarity between the amount of characteristics of the subsequent observation data and the amount of characteristics of the previous held observation data. The determination of similarity includes, for example, determining whether or not the amount of characteristics of the subsequent observation data representing a weather phenomenon lies within a certain distance from the amount of characteristics of the previous held observation data (weather condition vector). When the amount of characteristics of the subsequent observation data (weather condition vector) lies within the certain distance from the amount of characteristics of the previous observation data, they can be determined as similar. The vector distance can be provided by a known technique including the Euclidean distance, Manhattan distance, or Mahalanobis distance.

When the subsequent observation data is determined as having a similarity to the previous observation data at step S2014, the weather management apparatus 200 compares the Ground Truth label from the previous weather-related posted information with the result of weather sensing processing of the subsequent observation data. When the result of weather sensing processing of the subsequent observation data is different from the Ground Truth label from the previous weather-related posted information, the weather sensing section 221A outputs the category of precipitation particles by setting the Ground Truth label from the previous weather-related posted information as true. Alternatively, when the subsequent observation data is determined as having no similarity to the previous observation data, the weather sensing section 221A outputs the result of weather sensing processing of the subsequent observation data.

With such a configuration, the weather management apparatus 200 can output the result of weather sensing processing which reflects the Ground Truth label from the previous weather-related posted information in real time even when the criterion (weather sensing model 221a) is not changed in real time.

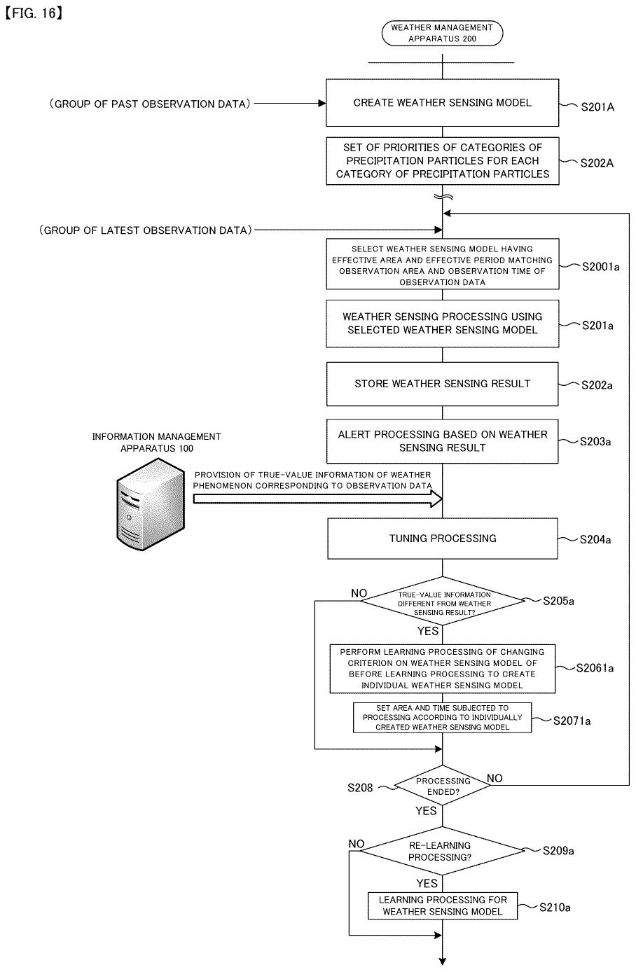

In Embodiment 4, similar to Embodiment 2 in which different criteria are held, the weather sensing model 221a after tuning can be created separately from the weather sensing model 221a before tuning. FIG. 16 is a diagram showing a flow of processing of creating multiple weather sensing models associated with different criteria and selecting one of the weather sensing models appropriate for input observation data to perform weather sensing processing in real-time processing of the second learning processing.

As shown in FIG. 16, when the weather phenomenon found in observation data is different from the weather phenomenon found in weather-related posted information (YES at S205a), the learning section 222A performs learning processing on the currently used weather sensing model 221a by setting the weather-related posted information as the Ground Truth label, thereby separately creating a weather sensing model 221a associated with the changed criterion (corresponding to a first weather sensing model) (S2061a). The learning section 222A sets an effective area and an effective period of the separately created weather sensing model 221a based on the observation area and observation time of observation data (S2071a).

Upon input of subsequent observation data, the weather sensing section 221A selects one of the weather sensing models 221a having different effective areas and effective periods that matches the observation area and observation time of the subsequent observation data (S2001a), and performs weather sensing processing on the subsequent observation data using the selected weather sensing model 221a (S201a).

When there is no weather sensing model 221a matching the observation area and observation time of the subsequent observation data at step S2001a, the weather sensing model 221A can be configured to select the weather sensing model 221a (reference model) created at step S201A or re-learned at step S210a to perform the weather sensing processing.

The configuration described above allows the multiple weather sensing models to be switched. The weather sensing model 221a created at step S201A or re-learned at step S210a can be configured as a reference model for long-time use, whereas the weather sensing models 221a separately created in real-time processing of the second learning processing can be used as models for short-term use with at least one of the criterion, effective area, and effective period different. The weather sensing section 221A can improve the accuracy of weather sensing processing by switching from the reference model for long-term use to one of the models for short-term use or switching between the models for short-term use depending on observation data. After the effective period (expiration period) of the weather sensing model 221a used, the weather sensing section 221A can switch to the reference model to perform the weather sensing processing.

Description is now made of the degree of reliability output from the weather sensing section 221A. The weather sensing model 221a uses weather-related posted information for use as the learning data. The weather sensing section 221A can calculate the degree of reliability of the weather sensing model 221a based on the evaluation values related to the weather-related posted information according to Embodiment 1 and output the calculated degree of reliability of the weather sensing model 221a together with the result of weather sensing processing. For example, the weather sensing section 221A can output information including the weather phenomenon “hail,” the area “OO city, OO prefecture,” and the degree of reliability “80%.”

Specifically, as described in Embodiment 1, the weather-related posted information can be evaluated by the poster evaluation value, the post accuracy evaluation value, and the weather phenomenon evaluation value. The information management apparatus 100 provides the weather management apparatus 200A with the true-value information and the evaluation values of weather-related posted information which provided the true-value information. The weather sensing section 221A can use the sum or at least one of the evaluation values of the weather-related posted information used as the learning data to calculate the degree of reliability of the weather sensing model 221a. For learning processing based on multiple different pieces of weather-related posted information, the mean value or median value of the evaluation values of those pieces of weather-related posted information can be calculated and used as the degree of reliability of the weather sensing model 221a. The degree of reliability can be calculated in any manner.

In addition, the weather sensing model 221a having a high degree of reliability can be created. Specifically, the evaluation values of the weather-related posted information can be used as an index in selecting which of pieces of weather-related posted information is used as learning data. For example, pieces of weather-related posted information accumulated over a certain time period are re-arranged in the order of the degree of reliability, and learning is started with the piece of weather-related posted information at the highest degree of reliability. The learning processing is terminated at the time when the desired result is achieved. For example, it is possible to perform weather sensing processing by using, as sample test data, input observation data which outputted a category different from the Ground Truth label, verify whether or not the same weather phenomenon category as the Ground Truth label is output, and end the learning when the result of verification equal to or higher than a predetermined value is achieved. The learning may also be performed by using learning data having an evaluation value equal to or higher than a certain value. Such a configuration can prevent learning processing based on learning data having a low degree of reliability as weather-related posted information to avoid over-training of the weather sensing model 221a.

The learning of the weather sensing model 221a, that is, the tuning of the criterion performed by the learning section 222A can be performed with any one or a combination of two or more of the following approaches. Description is made assuming that “A” represents the category of precipitation particles acquired from the weather sensing model 221a through the category determination processing on observation data, and “C” represents the category (weather phenomenon) of precipitation particles found in weather-related posted information.

(A) From the learning data learned so far, the learning section 222A extracts observation data which is within a certain similarity range from a weather phenomenon (weather condition) extracted from input observation data. The learning section 222A replaces the Ground Truth label “A” linked to the extracted observation data with “C.” In other words, the learning section 222A replaces the Ground Truth label of the observation data having a certain similarity as learning data with the category “C” of precipitation particles found in weather-related posted information. The learning section 222A performs re-learning processing using a group of observation data items having the Ground Truth label replaced with “C” as learning data to update the weather sensing model 221a.

The determination of similarity can be performed by the similarity determination processing of comparison between the amounts of characteristics of observation data items as described above. In the processing, the threshold value for determining whether or not observation data is within the certain similarity range can be dynamically changed. For example, when the result of output from the updated weather sensing model 221a is still the category “A” of precipitation particles, the learning section 222A can update (increase) the threshold value for determining whether or not observation data is within the certain similarity range to widen the distribution range applied as learning data, and perform the learning processing again to update the weather sensing model.

(B) For weather sensing processing using the possibility density function, the weather management apparatus 200A can be configured to calculate the possibilities of the categories (classifications) of precipitation particles based on input observation data and output the category having the highest probability. In this case, the learning section 222A can increase the probability at which input observation data is classified into the category “C” or reduce the probability at which input observation data is classified into “A.” The increase or reduction amount of the probability can be a preset fixed value or a dynamically changing value.

The weather management apparatus 200A may uniformly add or subtract an offset or change the probability density function itself in increasing or reducing the probability. For changing the probability density function, the weather management apparatus 200A may change the mean and variance of the probability density function, and the change amount may be a preset value or a dynamically changing value. For example, to increase the probability, the weather management apparatus 200A changes the mean value of the probability density function for the category “C” such that it is closer to the input value of the probability density function extracted from input observation data. In contrast, to reduce the probability, the weather management apparatus 200A changes the mean value of the probability density function for the category “A” such that it is farther from the input value of the probability density function extracted from input observation data. The result from the updated probability can be the final output. When the result from the updated probability is still the category “A,” similar operations may be repeated until the desired result is achieved.

(C) The probability density function as used in (B) described above can be provided for each amount of characteristics of a weather phenomenon (amount of characteristics of high-dimension vector) extracted from input observation data. In this case, the probability of each amount of characteristics can be multiplexed to calculate the final probability of each category. The probability of each amount of characteristics can be increased uniformly, or the amount of probability can be dynamically increased in response to the result from the probability. For example, the probability density function is provided for each of a characteristic amount 1, a characteristic amount 2, and a characteristic amount 3, and the probability of each characteristic amount is calculated for the category “B.” When the probability calculated from the characteristic amount 1 is 0.99, the probability calculated from the characteristic amount 2 is 0.91, the probability calculated from the characteristic amount 3 is 0.95, the probability of the characteristic amount 2 is increased significantly since the probability of the characteristic amount 2 is the lowest. The probability can be increased or reduced in the same way as that in (B) described above.

(D) When the probability density function in (B) described above is used and multiple pieces of weather-related posted information having a high evaluation value (degree of reliability) are acquired, the multiple Ground Truth labels can be used to update the probability density function. For example, the weather management apparatus 200A can utilize the Bayesian updating which uses the probability density as a prior distribution and finds a posterior distribution from the reliable result. The weather management apparatus 200A can update the probability density function of the category “C” using the posterior distribution as the probability density function and finally output the result based on the updated probability. When the result based on the updated probability still outputs the category “A,” similar operations can be repeatedly performed until the desired result is achieved.

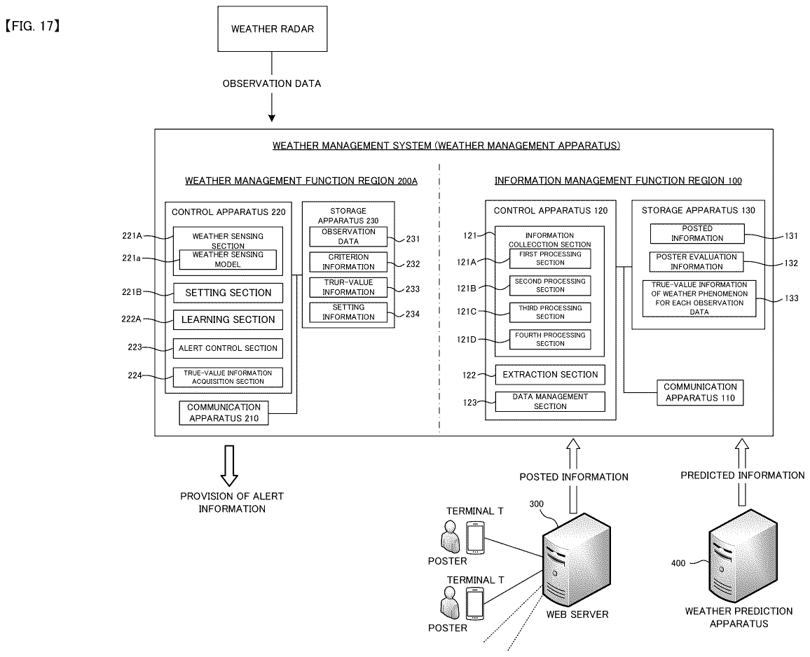

While the above description has been made of the aspect in which the weather management apparatus 200 cooperates with the information management apparatus 100 individually configured, the present invention is not limited thereto. For example, as shown in FIG. 17, a weather management apparatus or a weather management system can be configured to include the functional sections and the information of the information management apparatus 100. In this case, the weather management system can be configured to include the following configuration.

(1) The weather management system (weather management apparatus 200A) includes an information management section configured to acquire pieces of weather-related posted information from multiple pieces of posted information posted to a Web server configured to receive pieces of posted information from poster terminals and extract at least one of the pieces of weather-related posted information that matches an observation area and an observation time of observation data observed by a weather radar, a weather sensing section including a weather sensing model configured to perform processing of determining a category of precipitation particles within clouds in the sky based on the observation data and output a category of precipitation particles falling to the ground based on the result of the category determination processing, and
a learning section configured to use a weather phenomenon found in the weather-related posted information as learning data to learn the category of precipitation particles that actually fell to the ground with reference to the category of precipitation particles in the sky based on the observation data and create the weather sensing model.

The category determination processing of the weather management system in (1) can include classifying a weather phenomenon in the sky based on the observation data into a category according to the criterion set for each category of precipitation particles. The learning section performs learning processing by using the weather phenomenon found in the weather-related posted information corresponding to the observation data as the Ground Truth label to tune the criterion. In addition, the weather management system in (1) can include the functions of the weather sensing section 221A including the weather sensing model 221a and the learning section 222A according to Embodiment 4.

The replacement processing described in FIG. 15 (steps S201a to steps S208) can be configured as the weather management apparatus reflecting the true-value information through the replacement processing without changing the criterion and can include the following configuration.

(3) The weather management apparatus includes:
an analysis section configured to classify observation data from a weather radar according to a predetermined criterion and the result of analysis based on the classification; and
an information acquisition section configured to acquire the weather-related posted information corresponding to the observation data and output from the information management apparatus according to claim 1,
wherein the analysis section is configured to perform processing of determining a category of precipitation particles within clouds in the sky indicated by the observation data according to the criterion set for each category of precipitation particles and output a category of precipitation particles falling to the ground based on the result of the category determination processing,
the analysis section is configured to compare the weather phenomenon found in the weather-related posted information corresponding to the observation data with the output category of precipitation particles falling to the ground, and in response to determination of different weather phenomena, hold the observation data and the weather-related posted information determined as the different weather phenomena, and
the analysis section is configured to determine similarity between subsequent observation data and the held observation data, and in response to determination that there is similarity between the subsequent observation data and the held observation data, compare the weather phenomenon found in the held weather-related posted information with a category of precipitation particles falling to the ground output based on the subsequent observation data, and in response to determination that a weather phenomenon found from the subsequent observation data is different from the weather phenomenon found in the held weather-related posted information, output the weather phenomenon found in the held weather-related posted information as the result of weather sensing on the subsequent observation data.

Similarly to the illustration of FIG. 17, a weather management apparatus or a weather management system including the functional sections and the information of the information management apparatus 100 can be configured to include the following configuration.

(4) The weather management system includes an information management section configured to acquire pieces of weather-related posted information from multiple pieces of posted information posted to a Web server configured to receive pieces of posted information from poster terminals and extract at least one of the pieces of weather-related posted information that matches an observation area and an observation time of observation data observed by a weather radar,
a weather sensing section configured to perform processing of determining a category of precipitation particles within clouds in the sky based on the observation data and output a category of precipitation particles falling to the ground based on the result of the category determination processing.

The weather sensing section is configured to compare the weather phenomenon found in the weather-related posted information corresponding to the observation data with the category of precipitation particles falling to the ground output through the weather sensing processing, and in response to determination of different phenomena, hold the observation data and the weather-relate posted information determined as the different weather phenomena, and
the weather sensing section is configured to determine similarity between subsequent observation data and the held observation data, and in response to determination that there is similarity between the subsequent observation data and the temporarily held observation data, compare the weather phenomenon found in the held weather-related posted information with a category of precipitation particles falling to the ground output through the weather sensing processing with the subsequent observation data used as input, and in response to determination that a weather phenomenon found from the subsequent observation data is different from the weather phenomenon found in the held weather-related posted information, output the weather phenomenon found in the held weather-related posted information as the result of weather sensing on the subsequent observation data.

As described above, the weather management apparatus or the weather management system in (3), (4) can have the aspect of the system configuration that does not assume learning processing which reflects true-value information found from the weather-related posted information in the weather sensing processing itself. For example, the existing system for performing weather sensing processing cooperates with the information management apparatus 100 managing weather-related posted information and has the replacement processing function of replacing the category of precipitation particles output in the weather sensing processing with the weather phenomenon (Ground Truth label) found in the weather-related posted information corresponding to the previous observation data. Such a configuration allows improved accuracy in weather sensing without changing the weather sensing processing itself.

The alert output processing in the alert control section 223 can be configured to acquire many pieces weather-related posted information having a high level of reliability as a weather phenomenon. As described in Embodiment 2, the alert control section 223 can create and output alert information such as “Graupel may be falling in city A. Watch out.” The alert information can include a message inserted therein such as “What weather phenomena are observed near city A?Please post.” Such a configuration allows the information management apparatus 100 to acquire (collect) many pieces of weather-related posted information, which allows the weather management apparatus 200A to acquire many pieces of learning data. In addition, to provide alert information for users (user terminals) registered in the weather management apparatus 200, a push notification can be sent to the user terminals to collect many pieces of weather-related posted information. The mechanism of encouraging posts in conjunction with the alert output processing can be introduced to acquire posts about the weather phenomenon having a high degree of reliability (probability), improving the accuracy of the weather sensing model 221a.

Similarly to Embodiments 1 to 3, Embodiment 4 can perform weather sensing processing capable of sensing weather phenomena including tornados and whirlwinds.

The functions constituting the image management apparatus 100 and the weather management apparatus 200 described above can be implemented by a program. A computer program previously provided for implementing the functions can be stored on an auxiliary storage apparatus, the program stored on the auxiliary storage apparatus can be read by a control section such as a CPU to a main storage apparatus, and the program read to the main storage apparatus can be executed by the control section to achieve the functions of the respective components.

The program may be recorded on a computer readable recording medium and provided for the computer. Examples of the computer readable recording medium include optical disks such as CD-ROMs, phase-change optical disks such as DVD-ROMs, magneto-optical disks such as Magnet-Optical (MO) disks and Mini Disks (MD), magnetic disks such as floppy disks® and removable hard disks, and memory cards such as compact Flash®, smart media, SD memory cards, and memory sticks. Hardware apparatuses such as integrated circuits (such as IC chips) designed and configured specifically for the purpose of the present invention are included in the recording medium.

While the exemplary embodiments of the present invention have been described above, the embodiments are only illustrative and are not intended to limit the scope of the present invention. The novel embodiments can be implemented in various other forms, and various omissions, substitutions, and modifications can be made thereto without departing from the spirit or scope of the present invention. These embodiments and variations are encompassed within the spirit or scope of the present invention and within the invention set forth in the claims and the equivalents thereof.

### DESCRIPTION OF THE REFERENCE NUMERALS

100 IMAGE MANAGEMENT APPARATUS
110 COMMUNICATION APPARATUS
120 CONTROL APPARATUS
121 INFORMATION COLLECTION SECTION
121A FIRST PROCESSING SECTION
121B SECOND PROCESSING SECTION
121C THIRD PROCESSING SECTION
121D FOURTH PROCESSING SECTION
122 EXTRACTION SECTION
123 DATA MANAGEMENT SECTION
124 CLASSIFICATION CONTROL SECTION
130 STORAGE APPARATUS
131 POSTED INFORMATION
132 POSTER EVALUATION INFORMATION
133 TRUE-VALUE INFORMATION
134 CLASSIFICATION-RELATED INFORMATION
200, 200A WEATHER MANAGEMENT APPARATUS
210 COMMUNICATION APPARATUS
220 CONTROL APPARATUS
221 ANALYSIS SECTION
221A WEATHER SENSING SECTION
221a WEATHER SENSING MODEL
221B SETTING SECTION
222 CRITERION CONTROL SECTION
222B LEARNING SECTION
223 ALERT CONTROL SECTION
224 TRUE-VALUE INFORMATION ACQUISITION SECTION
230 STORAGE APPARATUS
231 OBSERVATION DATA
232 CRITERION INFORMATION
233 TRUE-VALUE INFORMATION
234 SETTING INFORMATION
300 WEB SERVER
400 WEATHER PREDICTION APPARATUS
T TERMINAL (POSTER TERMINAL)

1-19. (canceled)

20. A weather management system comprising:
an analysis section configured to classify observation data from a weather radar according to a predetermined criterion and to output a result of analysis based on the classification; and
a criterion control section configured to change the predetermined criterion based on a weather phenomenon found in weather-related posted information, the weather-related posted information posted to a Web server configured to receive posted information from poster terminals and matched the observation data observed by a weather radar.

21. The weather management system according to claim 20, further comprising:
an extraction section configured to extract the weather-related posted information that matches an observation area and an observation time of observation data observed by a weather radar from the weather-related posted information posted to the Web server configured to receive posted information from poster terminals; and
a data management section configured to output the weather phenomenon found in the extracted the weather-related posted information as a weather phenomenon corresponding to the observation data.

22. The weather management system according to claim 20, wherein the analysis section is further configured to perform processing of determining a category of precipitation particles by the observation data according to the criterion and to output determined the category of precipitation particles.

23. The weather management system according to claim 22, wherein the analysis section is further configured to perform processing of determining a category of precipitation particles within clouds in the sky indicated by the observation data according to the criterion and to output a category of precipitation particles falling to the ground based on a result of the category determination processing.

24. The weather management system according to claim 20, wherein the criterion control section is further configured:
to compare the weather phenomenon found in the weather-related posted information corresponding to the observation data with the result of analysis of the observation data in the analysis section,
not to perform processing of changing the criterion in response to determination of the same weather phenomenon, and
to perform the processing of changing the criterion based on the weather phenomenon found in the weather-related posted information corresponding to the observation data in response to determination of different weather phenomena.

25. The weather management system according to claim 20, wherein the criterion control section is further configured to change the criterion based on the weather phenomenon found in the weather-related posted information corresponding to the observation data such that an effective area and an effective period subjected to processing according to the changed criterion are set based on an observation area and an observation time of the observation data, and
the analysis section is further configured to determine whether or not an observation area and an observation time of subsequent observation data are within an effective range corresponding to the effective area and the effective period, and in response to determination that the observation area and the observation time are within the effective range, use the changed criterion in processing of analyzing the subsequent observation data.

26. The weather management system according to claim 20, further comprising:
an alert control section configured to output alert information based on the result of analysis.

27. A non-transitory computer readable medium including a computer executable program comprising instructions which, when executed by a computer, cause the computer to provide:
a first function of classifying observation data from a weather radar according to a predetermined criterion and of outputting a result of analysis based on the classification; and
a second function of changing the criterion based on a weather phenomenon found in weather-related posted information, the weather-related posted information posted to a Web server configured to receive posted information from poster terminals and matched the observation data observed by a weather radar.

28. The non-transitory computer readable medium including a computer executable program according to claim 27, to further cause the computer to provide:
a third function of outputting alert information based on the result of analysis.

29. A method of weather management, when executed by a computer, performs operations comprising:
classifying observation data from a weather radar according to a predetermined criterion and outputting a result of analysis based on the classification; and
changing the criterion based on a weather phenomenon found in weather-related posted information, the weather-related posted information posted to a Web server configured to receive posted information from poster terminals and matched the observation data observed by a weather radar.

30. The method of weather management according to claim 29, further performs operations comprising:
outputting alert information based on the result of analysis.
